(19) United States
(12) Patent Application Publication
(10) Pub. No.: US 2013/0268129 A1
(43) Pub. Date: Oct. 10, 2013

(54) HVAC CONTROL SYSTEM WITH INTERCHANGEABLE CONTROL UNITS

(71) Applicant: NEST LABS, INC., Palo Alto, CA (US)

(72) Inventors: Anthony M. Fadell, Portola Valley, CA (US); Matthew L. Rogers, Los Gatos, CA (US); Yoky Matsuoka, Palo Alto, CA (US); David Sloo, Menlo Park, CA (US)

(21) Appl. No.: 13/831,216

(22) Filed: Mar. 14, 2013

Related U.S. Application Data
(63) Continuation-in-part of application No. PCT/US12/00007, filed on Jan. 3, 2012.
(60) Provisional application No. 61/429,093, filed on Dec. 31, 2010.

(51) Int. Cl. G05D 23/19

(52) U.S. Cl. CPC G05D 23/1917
USPC 700/278

(57) ABSTRACT

Embodiments of the present invention provide a temperature control system having multiple programmable, interchangeable docking thermostats that work cooperatively making it easier for a user to achieve desired temperature control in an enclosure with increased energy efficiency. One embodiment provides first and second docking thermostats each having a microprocessor in communication with at least one or more temperature sensors, an electrical connector connected to the microprocessor and a user interface. Also provided is a first HVAC docking device directly wired to the HVAC wire system and a second docking device that connects to a power source other than the HVAC wire system, where each of the docking devices have an electrical connector mateable to the electrical connector of the docking thermostats. The first and second docking thermostats may interchangeably mate to the docking devices, and either may control the HVAC system to achieve a desired comfort level with increased energy efficiency.

### CROSS-REFERENCE TO RELATED APPLICATIONS

This application is a continuation-in-part application of PCT/US2012/00007 (NES0190-PCT), filed on Jan. 3, 2012, which claims the benefit of U.S. Provisional Application Ser. No. 61/429,093 filed Dec. 31, 2010. Each of the above-referenced patent applications is incorporated by reference herein.

### COPYRIGHT AUTHORIZATION

A portion of the disclosure of this patent document may contain material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

This patent specification relates to the judicious monitoring and control of resource usage. For some embodiments, this patent specification relates to the judicious monitoring and control of heating, cooling, and air conditioning (HVAC) system energy usage in a manner that promotes an optimal combination of energy savings and human comfort. The teachings of this patent specification are readily applied in other resource usage contexts as well (e.g., water usage, air usage, usage of other natural resources, and usage of various forms of energy).

### BACKGROUND

While substantial effort and attention continues toward the development of newer and more sustainable energy supplies, the conservation of energy by increased energy efficiency remains crucial to the world's energy future. According to an October 2010 report from the U.S. Department of Energy, heating and cooling account for 56% of the energy use in a typical U.S. home, making it the largest energy expense for most homes. Along with improvements in the physical plant associated with home heating and cooling (e.g., improved insulation, higher efficiency furnaces), substantial increases in energy efficiency can be achieved by better control and regulation of home heating and cooling equipment. By activating heating, ventilation, and air conditioning (HVAC) equipment for judiciously selected time intervals and carefully chosen operating levels, substantial energy can be saved while at the same time keeping the living space suitably comfortable for its occupants.

Historically, however, most known HVAC thermostatic control systems have tended to fall into one of two opposing categories, neither of which is believed optimal in most practical home environments. In a first category are many simple, non-programmable home thermostats, each typically consisting of a single mechanical or electrical dial for setting a desired temperature and a single HEAT-FAN-OFF-AC switch. While being easy to use for even the most unsophisticated occupant, any energy-saving control activity, such as adjusting the nighttime temperature or turning off all heating/cooling just before departing the home, must be performed manually by the user. As such, substantial energy-saving opportunities are often missed for all but the most vigilant users. Moreover, more advanced energy-saving settings are not provided, such as the ability to specify a custom temperature swing, i.e., the difference between the desired set temperature and actual current temperature (such as 1 to 3 degrees) required to trigger turn-on of the heating/cooling unit.

In a second category, on the other hand, are many programmable thermostats, which have become more prevalent in recent years in view of Energy Star (US) and TCO (Europe) standards, and which have progressed considerably in the number of different settings for an HVAC system that can be individually manipulated. Unfortunately, however, users are often intimidated by a dizzying array of switches and controls laid out in various configurations on the face of the thermostat or behind a panel door on the thermostat, and seldom adjust the manufacturer defaults to optimize their own energy usage. Thus, even though the installed programmable thermostats in a large number of homes are technologically capable of operating the HVAC equipment with energy-saving profiles, it is often the case that only the one-size-fits-all manufacturer default profiles are ever implemented in a large number of homes. Indeed, in an unfortunately large number of cases, a home user may permanently operate the unit in a “temporary” or “hold” mode, manually manipulating the displayed set temperature as if the unit were a simple, non-programmable thermostat.

At a more general level, because of the fact that human beings must inevitably be involved, there is a tension that arises between (i) the amount of energy-saving sophistication that can be offered by an HVAC control system, and (ii) the extent to which that energy-saving sophistication can be put to practical, everyday use in a large number of homes. Similar issues arise in the context of multi-unit apartment buildings, hotels, retail stores, office buildings, industrial buildings, and more generally any living space or work space having one or more HVAC systems. Other issues arise as would be apparent to one skilled in the art upon reading the present disclosure.

It is to be appreciated that although exemplary embodiments are presented herein for the particular context of HVAC system control, there are a wide variety of other resource usage contexts for which the embodiments are readily applicable including, but not limited to, water usage, air usage, the usage of other natural resources, and the usage of other (i.e., non-HVAC-related) forms of energy, as would be apparent to the skilled artisan in view of the present disclosure. Therefore, such application of the embodiments in such other resource usage contexts is not outside the scope of the present teachings.

### SUMMARY

Provided according to some embodiments is a programmable device, such as a thermostat, for control of an HVAC system. Configurations and positions of device components allow for the device to improve energy conservation and to simultaneously allow users to experience pleasant interactions with the device (e.g., to set preferences). The device has an outer ring that is rotatable, such that a user may circularly scroll through selection options (e.g., corresponding to temperature set points). For example, a set point temperature may gradually increase as a user rotates the ring in a clockwise direction. Inward pressing of the outer ring may also allow a user to view an interactive menuing system. The user may interact with the menuing system via rotations and/or inward pressings of the outer ring. Thus, the user may be provided with an intuitive and powerful system in which a set point temperature and other thermostat operational controls may be set.

In addition, embodiments in accordance with the present invention may include multiple interchangeable or docking thermostats, one which sends control signals to the HVAC system the others to act in concert, thereby increasing the ease with which a user can manage the ambient temperature of an enclosure, such as a home, apartment office or hotel room. An embodiment of a temperature control system, according to the present invention, comprises a first docking thermostat, a second docking thermostat, a first HVAC docking station (connected to the wires of the HVAC system), and a second docking station having a power source other than the wires of the HVAC system. The first and second docking thermostats have first and second housings, first and second user-interface components including first and second interactive graphical user interfaces, where each of the interfaces is configured to receive control inputs from a user. Control inputs may include, by way of example, adjusting a temperature setting, or turning the power on such that the other thermostat knows there is another thermostat on-line. The first and second docking thermostats also include first and second microprocessors within the respective housings of the thermostats, where the microprocessors are in operative communication with the respective user-interface components, have an electrical connector coupled thereto, and are in operative communication with one or more temperature sensors for determining ambient temperature at or around the temperature sensor. The docking thermostats also each have a wireless communication module associated with the respective thermostat, such that communications can take place directly between the docking thermostats, through the Internet, or by other suitable means known to the skilled artisan. It will be appreciated that the temperature control system of this embodiment may comprise more the two docking thermostats.

This embodiment of the temperature control system also has an HVAC docking device and a remote or second docking device. Each docking device can mate with any of the docking thermostats, and each has an electrical connector that mates with the electrical connector of the docking thermostats. One difference between the docking devices is that the HVAC docking device is directly wired to the HVAC electrical system, and the other docking device is not. The docking thermostat mated to the HVAC docking device has the ability to transmit signals to the HVAC system by virtue of mating the electrical connectors of the docking thermostat and the HVAC docking device, and also has the ability to receive power from the HVAC system's wiring. The second or remote docking device provides power to its mated docking thermostat from a source other than wires of the HVAC system, for example and not by way of limitation, rechargeable batteries, rechargeable batteries plus an AC connection, or solely an AC connection to a wall outlet or direct wiring to a power source other than the HVAC wiring system.

As discussed, the docking thermostats are interchangeable, but only the docking thermostat mated to the HVAC docking device is capable of sending signals to the HVAC system. It will be appreciated that more than one HVAC docking device may be provided, for example in an enclosure with multiple HVAC systems. However, a docking thermostat mated to another non-HVAC docking device can control the HVAC system by virtue of sending commands to the docking thermostat mated to the HVAC docking device to transmit control signals to the HVAC system. Thus, and by way of example and not limitation, a user making an input (a temperature input, or just turning the power on, for example) to the docking thermostat mated to the non-HVAC docking device may cause this docking thermostat to override or control the other docking thermostat mated to the HVAC docking device. In further embodiments, no matter which docking device is controlling the HVAC system it can acquire and use ambient temperature data from a temperature sensor associated with the other docking thermostat in order to control the HVAC system. For example, and not by way of limitation, the controlling docking thermostat can control the HVAC system to have an arithmetic mean or weighted average of the ambient temperature at or around the temperature sensors achieve the temperature set point at the docking thermostat that is controlling the HVAC system.

Some embodiments of the present invention have two different configurations. The first configuration has the second docking thermostat mated to the second, non-HVAC docking device, and first docking thermostat mated to the first HVAC docking device. In this first configuration, the second docking thermostat may control the HVAC system by wireless communication with the first docking thermostat where the first docking thermostat may transmit control signals to the HVAC system in accordance with instructions communicated from the second docking thermostat. The second configuration has the second docking thermostat mated to the first HVAC docking device and the first docking thermostat mated to the second non-HVAC docking device where the first docking thermostat may control the HVAC system by wireless communication with the second docking thermostat, where the second docking thermostat may transmit control signals to the HVAC system in accordance with instructions communicated from the first docking thermostat.

### BRIEF DESCRIPTION OF THE DRAWINGS

FIG. 1A illustrates a perspective view of a versatile sensing and control unit (VSCU unit) according to an embodiment;

FIGS. 1B-1C illustrate the VSCU unit as it is being controlled by the hand of a user according to an embodiment;

FIG. 2A illustrates the VSCU unit as installed in a house having an HVAC system and a set of control wires extending therefrom;

FIG. 2B illustrates an exemplary diagram of the HVAC system of FIG. 2A;

FIGS. 3A-3K illustrate user temperature adjustment based on rotation of the outer ring along with an ensuing user interface display according to one embodiment;

FIG. 4 illustrates a data input functionality provided by the user interface of the VSCU unit according to an embodiment;

FIG. 5 illustrates an exploded perspective view of the VSCU unit and an HVAC-coupling wall dock according to an embodiment;

FIG. 6 illustrates conceptual diagrams of HVAC-coupling wall docks, according to some embodiments;

FIG. 7 illustrates an exploded perspective view of the VSCU unit and an HVAC-coupling wall dock according to an embodiment;

FIGS. 8A-8C illustrate conceptual diagrams representative of advantageous scenarios in which multiple VSCU units are installed in a home or other space according to embodiments in which the home (or other space) does not have a wireless data network;

FIG. 8D illustrates cycle time plots for two HVAC systems in a two-zone home heating (or cooling) configuration, according to an embodiment;

FIG. 9 illustrates a conceptual diagram representative of an advantageous scenario in which one or more VSCU units are installed in a home that is equipped with WiFi wireless connectivity and access to the Internet;

FIG. 10 illustrates a conceptual diagram of a larger overall energy management network as enabled by the VSCU units and VSCU Efficiency Platform described herein;

FIGS. 11A-11B and FIGS. 12A-12B illustrate examples of remote graphical user interface displays presented to the user on their data appliance for managing their one or more VSCU units and/or otherwise interacting with their VSCU Efficiency Platform equipment or data according to an embodiment;

### DETAILED DESCRIPTION

Provided according to one or more embodiments are systems, methods, computer program products, and related business methods for controlling one or more HVAC systems based on one or more versatile sensing and control units (VSCU units) also referred to herein as thermostats, each VSCU unit being configured and adapted to provide sophisticated, customized, energy-saving HVAC control functionality while at the same time being visually appealing, non-intimidating, elegant to behold, and delightfully easy to use. Each VSCU unit is advantageously provided with a selectively layered functionality, such that unsophisticated users are only exposed to a simple user interface, but such that advanced users can access and manipulate many different energy-saving and energy tracking capabilities. Importantly, even for the case of unsophisticated users who are only exposed to the simple user interface, the VSCU unit provides advanced energy-saving functionality that runs in the background, the VSCU unit quietly using multi-sensor technology to “learn” about the home's heating and cooling environment and optimizing the energy-saving settings accordingly.

The VSCU unit also “learns” about the users themselves, beginning with a congenial “setup interview” in which the user answers a few simple questions, and then continuing over time using multi-sensor technology to detect user occupancy patterns (e.g., what times of day they are home and away) and by tracking the way the user controls the set temperature on the dial over time. The multi-sensor technology is advantageously hidden away inside the VSCU unit itself, thus avoiding the hassle, complexity, and intimidation factors associated with multiple external sensor-node units. On an ongoing basis, the VSCU unit processes the learned and sensed information according to one or more advanced control algorithms, and then automatically adjusts its environmental control settings to optimize energy usage while at the same time maintaining the living space at optimal levels according to the learned occupancy patterns and comfort preferences of the user. Even further, the VSCU unit is programmed to promote energy-saving behavior in the users themselves by virtue of displaying, at judiciously selected times on its visually appealing user interface, information that encourages reduced energy usage, such as historical energy cost performance, forecasted energy costs, and even fun game-style displays of congratulations and encouragement.

Advantageously, the selectively layered functionality of the VSCU unit allows it to be effective for a variety of different technological circumstances in home and business environments, thereby making the same VSCU unit readily saleable to a wide variety of customers. For simple environments having no wireless home network or internet connectivity, the VSCU unit operates effectively in a standalone mode, being capable of learning and adapting to its environment based on multi-sensor technology and user input, and optimizing HVAC settings accordingly. However, for environments that do indeed have home network or internet connectivity, the VSCU unit operates effectively in a network-connected mode to offer a rich variety of additional capabilities. In some embodiments, whether in network-connected environment or a simple environment, a system may have more than one unit, where the units wireless communicate directly with each other or over a network, if one is available, and where the units are remotely located from each other. Such a multi unit system may provide benefits for comfort and/or better energy savings, as will be more fully described below.

When the VSCU unit is connected to the internet via a home network, such as through IEEE 802.11 (Wi-Fi) connectivity, additional capabilities provided according to one or more embodiments include, but are not limited to: providing real time or aggregated home energy performance data to a utility company, a VSCU data service provider, other VSCU units in other homes, or other data destinations; receiving real time or aggregated home energy performance data from a utility company, a VSCU data service provider, other VSCU units in other homes, or other data sources; receiving new energy control algorithms or other software/firmware upgrades from one or more VSCU data service providers or other sources; receiving current and forecasted weather information for inclusion in energy-saving control algorithm processing; receiving user control commands from the user's computer, network-connected television, smart phone, or other stationary or portable data communication appliance (hereinafter collectively referenced as the user's “digital appliance”); providing an interactive user interface to the user through their digital appliance; receiving control commands and information from an external energy management advisor, such as a subscription-based service aimed at leveraging collected information from multiple sources to generate the best possible energy-saving control commands or profiles for their subscribers; receiving control commands and information from an external energy management authority, such as a utility company to whom limited authority has been voluntarily given to control the VSCU in exchange for rebates or other cost incentives (e.g., for energy emergencies, “spare the air” days, etc.); providing alarms, alerts, or other information to the user on their digital appliance (and/or a user designee such as a home repair service) based on VSCU-sensed HVAC-related events (e.g., the house is not heating up or cooling down as expected); providing alarms, alerts, or other information to the user on their digital appliance (and/or a user designee such as a home security service or the local police department) based on VSCU-sensed non-HVAC related events (e.g., an intruder alert as sensed by the VSCU's multi-sensor technology); and a variety of other useful functions enabled by network connectivity as disclosed in one or more of the examples provided further hereinbelow.

It is to be appreciated that while one or more embodiments is detailed herein for the context of a residential home, such as a single-family home, the scope of the present teachings is not so limited, the present teachings being likewise applicable, without limitation, to duplexes, townhomes, multi-unit apartment buildings, hotels, retail stores, office buildings, industrial buildings, and more generally any living space or work space having one or more HVAC systems. It is to be further appreciated that while the terms user, customer, installer, homeowner, occupant, guest, tenant, landlord, repair person, and the like may be used to refer to the person or persons who are interacting with the VSCU unit or other device or user interface in the context of some particularly advantageous situations described herein, these references are by no means to be considered as limiting the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, and is also one of the users of the unit and is a customer of the utility company and/or VSCU data service provider. However, in other scenarios, such as a landlord-tenant environment, the customer may be the landlord with respect to purchasing the unit, the installer may be a local apartment supervisor, a first user may be the tenant, and a second user may again be the landlord with respect to remote control functionality. Importantly, while the identity of the person performing the action may be germane to a particular advantage provided by one or more of the embodiments—for example, the password-protected temperature governance functionality described further herein may be particularly advantageous where the landlord holds the sole password and can prevent energy waste by the tenant—such identity should not be construed in the descriptions that follow as necessarily limiting the scope of the present teachings to those particular individuals having those particular identities.

As used herein, “set point” or “temperature set point” refers to a target temperature setting of a temperature control system, such as one or more of the VSCU units described herein, as set by a user or automatically according to a schedule or algorithm. As would be readily appreciated by a person skilled in the art, many of the disclosed thermostatic functionalities described hereinbelow apply, in counterpart application, to both the heating and cooling contexts, with the only difference being in the particular set points and directions of temperature movement. To avoid unnecessary repetition, some examples of the embodiments may be presented herein in only one of these contexts, without mentioning the other. Therefore, where a particular embodiment or example is set forth hereinbelow in the context of home heating, the scope of the present teachings is likewise applicable to the counterpart context of home cooling, and vice versa, to the extent such counterpart application would be logically consistent with the disclosed principles as adjudged by the skilled artisan.

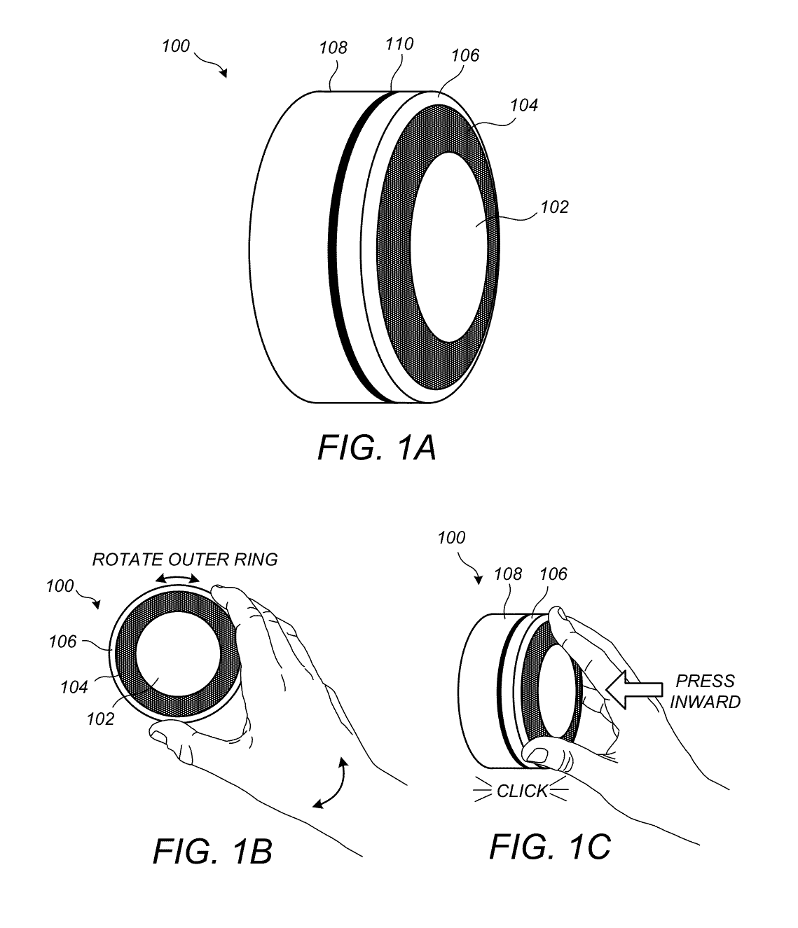

FIG. 1A illustrates a perspective view of a versatile sensing and control unit (VSCU unit) 100 according to an embodiment. Unlike so many prior art thermostats, the VSCU unit 100 preferably has a sleek, elegant appearance that does not detract from home decoration, and indeed can serve as a visually pleasing centerpiece for the immediate location in which it is installed. The VSCU unit 100 comprises a main body 108 that is preferably circular with a diameter of about 8 cm, and that has a visually pleasing outer finish, such as a satin nickel or chrome finish. Separated from the main body 108 by a small peripheral gap 110 is a cap-like structure comprising a rotatable outer ring 106, a sensor ring 104, and a circular display monitor 102. The outer ring 106 preferably has an outer finish identical to that of the main body 108, while the sensor ring 104 and circular display monitor 102 have a common circular glass (or plastic) outer covering that is gently arced in an outward direction and that provides a sleek yet solid and durable-looking overall appearance. The sensor ring 104 contains any of a wide variety of sensors including, without limitation, infrared sensors, visible-light sensors, and acoustic sensors. Preferably, the glass (or plastic) that covers the sensor ring 104 is smoked or mirrored such that the sensors themselves are not visible to the user. An air venting functionality is preferably provided, such as by virtue of the peripheral gap 110, which allows the ambient air to be sensed by the internal sensors without the need for visually unattractive “gills” or grill-like vents.

FIGS. 1B-1C illustrate the VSCU unit 100 as it is being controlled by the hand of a user according to an embodiment. In one embodiment, for the combined purposes of inspiring user confidence and further promoting visual and functional elegance, the VSCU unit 100 is controlled by only two types of user input, the first being a rotation of the outer ring 106 (FIG. 1B), and the second being an inward push on the outer ring 106 (FIG. 1C) until an audible and/or tactile “click” occurs. For one embodiment, the inward push of FIG. 1C only causes the outer ring 106 to move forward, while in another embodiment the entire cap-like structure, including both the outer ring 106 and the glass covering of the sensor ring 104 and circular display monitor 102, move inwardly together when pushed. Preferably, the sensor ring 104, the circular display monitor 102, and their common glass covering do not rotate with outer ring 106.

By virtue of user rotation of the outer ring 106 (referenced hereafter as a “ring rotation”) and the inward pushing of the outer ring 106 (referenced hereinafter as an “inward click”) responsive to intuitive and easy-to-read prompts on the circular display monitor 102, the VSCU unit 100 is advantageously capable of receiving all necessary information from the user for basic setup and operation. Preferably, the outer ring 106 is mechanically mounted in a manner that provides a smooth yet viscous feel to the user, for further promoting an overall feeling of elegance while also reducing spurious or unwanted rotational inputs. For one embodiment, the VSCU unit 100 recognizes three fundamental user inputs by virtue of the ring rotation and inward click: (1) ring rotate left, (2) ring rotate right, and (3) inward click. For other embodiments, more complex fundamental user inputs can be recognized, such as “double-click” or “triple-click” inward presses, and such as speed-sensitive or acceleration-sensitive rotational inputs (e.g., a very large and fast leftward rotation specifies an “Away” occupancy state, while a very large and fast rightward rotation specifies an “Occupied” occupancy state).

Although the scope of the present teachings is not so limited, it is preferred that there not be provided a discrete mechanical HEAT-COOL toggle switch, or HEAT-OFF-COOL selection switch, or HEAT-FAN-OFF-COOL switch anywhere on the VSCU unit 100, this omission contributing to the overall visual simplicity and elegance of the VSCU unit 100 while also facilitating the provision of advanced control abilities that would otherwise not be permitted by the existence of such a switch. It is further highly preferred that there be no electrical proxy for such a discrete mechanical switch (e.g., an electrical push button or electrical limit switch directly driving a mechanical relay). Instead, it is preferred that the switching between these settings be performed under computerized control of the VSCU unit 100 responsive to its multi-sensor readings, its programming (optionally in conjunction with externally provided commands/data provided over a data network), and/or the above-described “ring rotation” and “inward click” user inputs.

The VSCU unit 100 comprises physical hardware and firmware configurations, along with hardware, firmware, and software programming that is capable of carrying out the functionalities described in the instant disclosure. In view of the instant disclosure, a person skilled in the art would be able to realize the physical hardware and firmware configurations and the hardware, firmware, and software programming that embody the physical and functional features described herein without undue experimentation using publicly available hardware and firmware components and known programming tools and development platforms. Similar comments apply to described devices and functionalities extrinsic to the VSCU unit 100, such as devices and programs used in remote data storage and data processing centers that receive data communications from and/or that provide data communications to the VSCU unit 100.

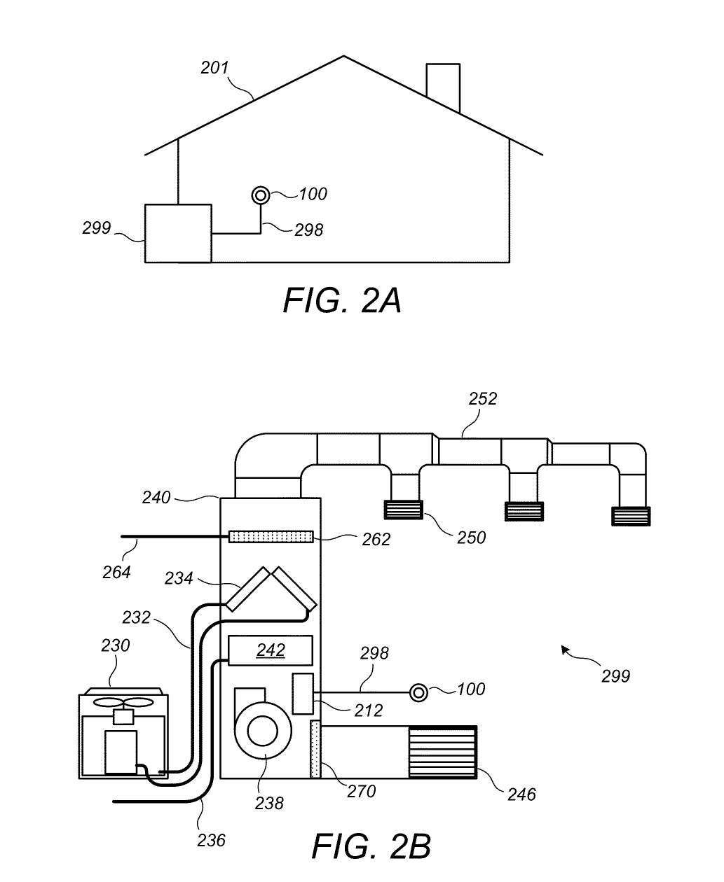

FIG. 2A illustrates the VSCU unit 100 as installed in a house 201 having an HVAC system 299 and a set of control wires 298 extending therefrom. The VSCU unit 100 is, of course, extremely well suited for installation by contractors in new home construction and/or in the context of complete HVAC system replacement. However, one alternative key business opportunity leveraged according to one embodiment is the marketing and retailing of the VSCU unit 100 as a replacement thermostat in an existing homes, wherein the customer (and/or an HVAC professional) disconnects their old thermostat from the existing wires 298 and substitutes in the VSCU unit 100. Additionally, however, as homeowners “warm up” to the VSCU unit 100 platform and begin to further appreciate its delightful elegance and seamless operation, they will be more inclined to take advantage of its advanced features, and they will furthermore be more open and willing to embrace a variety of compatible follow-on products and services as are described further hereinbelow. For clarity of disclosure, the term “VSCU Efficiency Platform” refers herein to products and services that are technologically compatible with the VSCU unit 100 and/or with devices and programs that support the operation of the VSCU unit 100. Further details of these opportunities and advantages may be found in one or more of the following commonly assigned applications, each of which is incorporated by reference herein: Provisional U.S. Application Ser. No. 61/704,437 filed Sep. 21, 2012; U.S. patent application Ser. No. 13/632,148 filed Sep. 30, 2012; U.S. patent application Ser. No. 13/467,025 filed May 8, 2012; PCT/US2012/020026 filed Jan. 3, 2012; and U.S. patent application Ser. No. 13/269,501 filed Oct. 7, 2011.

FIG. 2B illustrates an exemplary diagram of the HVAC system 299 of FIG. 2A. HVAC system 299 provides heating, cooling, ventilation, and/or air handling for an enclosure, such as the single-family home 201 depicted in FIG. 2A. The HVAC system 299 depicts a forced air type heating system, although according to other embodiments, other types of systems could be used. In heating, heating coils or elements 242 within air handler 240 provide a source of heat using electricity or gas via line 236. Cool air is drawn from the enclosure via return air duct 246 through filter 270 using fan 238 and is heated by the heating coils or elements 242. The heated air flows back into the enclosure at one or more locations through a supply air duct system 252 and supply air grills such as grill 250. In cooling, an outside compressor 230 passes a gas such as Freon through a set of heat exchanger coils to cool the gas. The gas then goes via line 232 to the cooling coils 234 in the air handlers 240 where it expands, and cools the air being circulated through the enclosure via fan 238. According to some embodiments a humidifier 262 is also provided which moistens the air using water provided by a water line 264. Although not shown in FIG. 2B, according to some embodiments the HVAC system for the enclosure has other known components such as dedicated outside vents to pass air to and from the outside, one or more dampers to control airflow within the duct systems, an emergency heating unit, and a dehumidifier. The HVAC system is selectively actuated via control electronics 212 that communicate with the VSCU 100 over control wires 298.

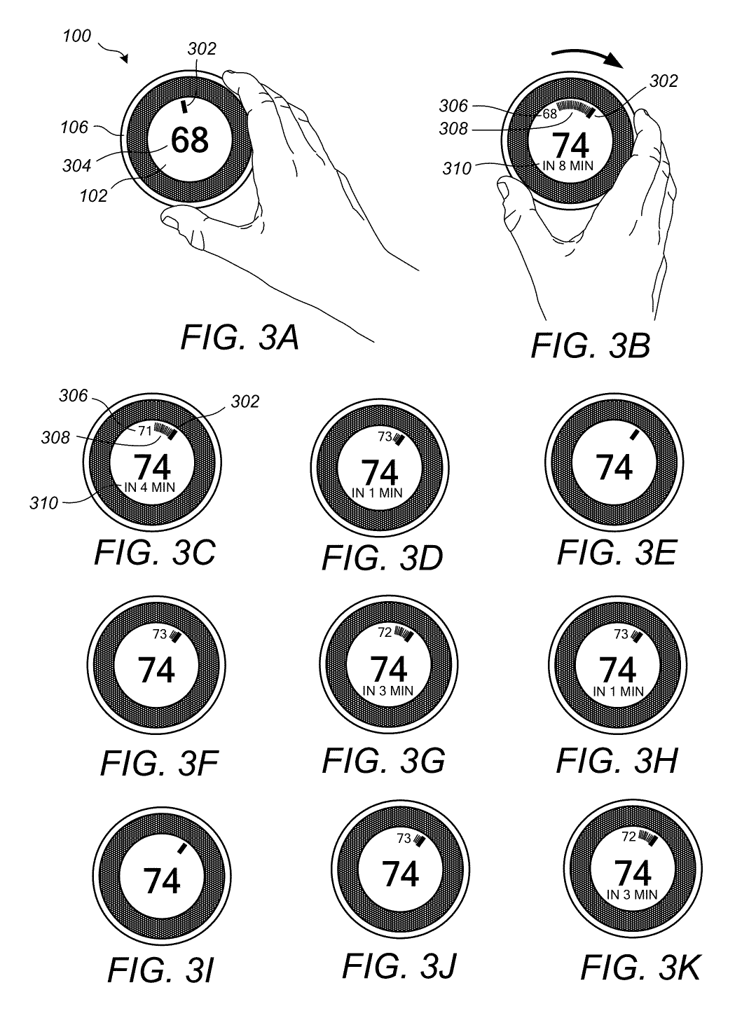

FIGS. 3A-3K illustrate user temperature adjustment based on rotation of the outer ring 106 along with an ensuing user interface display according to one embodiment. For one embodiment, prior to the time depicted in FIG. 3A in which the user has walked up to the VSCU unit 100, the VSCU unit 100 has set the circular display monitor 102 to be entirely blank (“dark”), which corresponds to a state of inactivity when no person has come near the unit. As the user walks up to the display, their presence is detected by one or more sensors in the VSCU unit 100 at which point the circular display monitor 102 is automatically turned on. When this happens, as illustrated in FIG. 3A, the circular display monitor 102 displays the current set point in a large font at a center readout 304. Also displayed is a set point icon 302 disposed along a periphery of the circular display monitor 102 at a location that is spatially representative of the current set point. Although it is purely electronic, the set point icon 302 is reminiscent of older mechanical thermostat dials, and advantageously imparts a feeling of familiarity for many users as well as a sense of tangible control.

Notably, the example of FIG. 3A assumes a scenario for which the actual current temperature of 68 is equal to the set point temperature of 68 when the user has walked up to the VSCU unit 100. For a case in which the user walks up to the VSCU unit 100 when the actual current temperature is different than the set point temperature, the display would also include an actual temperature readout and a trailing icon, which are described further below in the context of FIGS. 3B-3K.

Referring now to FIG. 3B, as the user turns the outer ring 106 clockwise, the increasing value of the set point temperature is instantaneously provided at the center readout 304, and the set point icon 302 moves in a clockwise direction around the periphery of the circular display monitor 102 to a location representative of the increasing set point. Whenever the actual current temperature is different than the set point temperature, an actual temperature readout 306 is provided in relatively small digits along the periphery of the circular a location spatially representative the actual current temperature. Further provided is a trailing icon 308, which could alternatively be termed a tail icon or difference-indicator that extends between the location of the actual temperature readout 306 and the set point icon 302. Further provided is a time-to-temperature readout 310 that is indicative of a prediction, as computed by the VSCU unit 100, of the time interval required for the HVAC system to bring the temperature from the actual current temperature to the set point temperature.

FIGS. 3C-3K illustrate views of the circular display monitor 102 at exemplary instants in time after the user set point change that was completed in FIG. 3B (assuming, of course, that the circular display monitor 102 has remained active, such as during a preset post-activity time period, responsive to the continued proximity of the user, or responsive the detected proximity of another occupant). Thus, at FIG. 3C, the current actual temperature is about halfway up from the old set point to the new set point, and in FIG. 3D the current actual temperature is almost at the set point temperature. As illustrated in FIG. 3E, both the trailing icon 308 and the actual temperature readout 306 disappear when the current actual temperature reaches the set point temperature and the heating system is turned off. Then, as typically happens in home heating situations, the actual temperature begins to sag (FIG. 3F) until the permissible temperature swing is reached (which is 2 degrees in this example, see FIG. 3G), at which point the heating system is again turned on and the temperature rises to the set point (FIGS. 3H-3I) and the heating system is turned off. The current actual temperature then begins to sag again (FIGS. 3J-3K), and the cycle continues. Advantageously, by virtue of the user interface functionality of FIGS. 3A-3K including the time-to-temperature readout 310, the user is provided with a fast, intuitive, visually pleasing overview of system operation, as well as a quick indication of how much longer the heating system (or cooling system in counterpart embodiments) will remain turned on. It is to be appreciated that the use of 2 degrees as the permissible temperature swing in FIGS. 3C-3K are only for purposes of example, and that different amounts of permissible temperature swing may be applicable at different times according to the particular automated control algorithms, defaults, user settings, user overrides, etc. that may then be in application at those times.

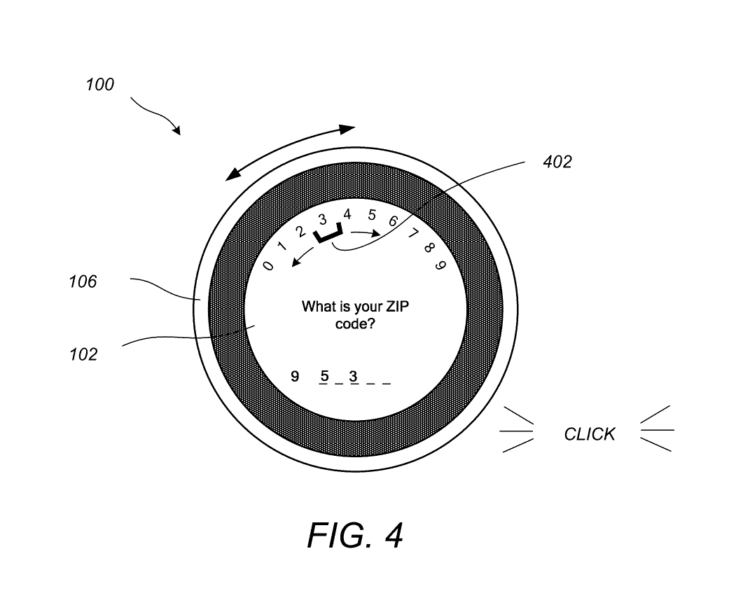

FIG. 4 illustrates a data input functionality provided by the user interface of the VSCU unit 100, according to an embodiment, in which the user is asked, during a congenial setup interview (which can occur at initial VSCU unit installation or at any subsequent time that the user may request), to enter their ZIP code. Responsive to a display of digits 0-9 distributed around a periphery of the circular display monitor 102 along with a selection icon 402, the user turns the outer ring 106 to move the selection icon 402 to the appropriate digit, and then provides an inward click command to enter that digit. Other data, as will be appreciated by the skilled artisan, can be input or displayed using the user interface of the VSCU unit 100. For example, and not by way of limitation, entering of passwords, responding to various ‘interview’ or setup questions, displaying encouragement for reducing energy consumption (e.g. leaf icons, or a points system), recent energy use (daily, weekly, monthly, etc.), displaying of energy savings as compared to community and the like. Further descriptions of these and other beneficial data entry, data use and data display may be found in one or more of the above-referenced incorporated commonly assigned patent applications.

For some embodiments, the VSCU unit 100 is manufactured and sold as a single, monolithic structure containing all of the required electrical and mechanical connections on the back of the unit. For some embodiments, the VSCU 100 is manufactured and/or sold in different versions or packaging groups depending on the particular capabilities of the manufacturer(s) and the particular needs of the customer. For example, the VSCU unit 100 is provided in some embodiments as the principal component of a two-part combination consisting of the VSCU 100 and one of a variety of dedicated docking devices, as described further hereinbelow.

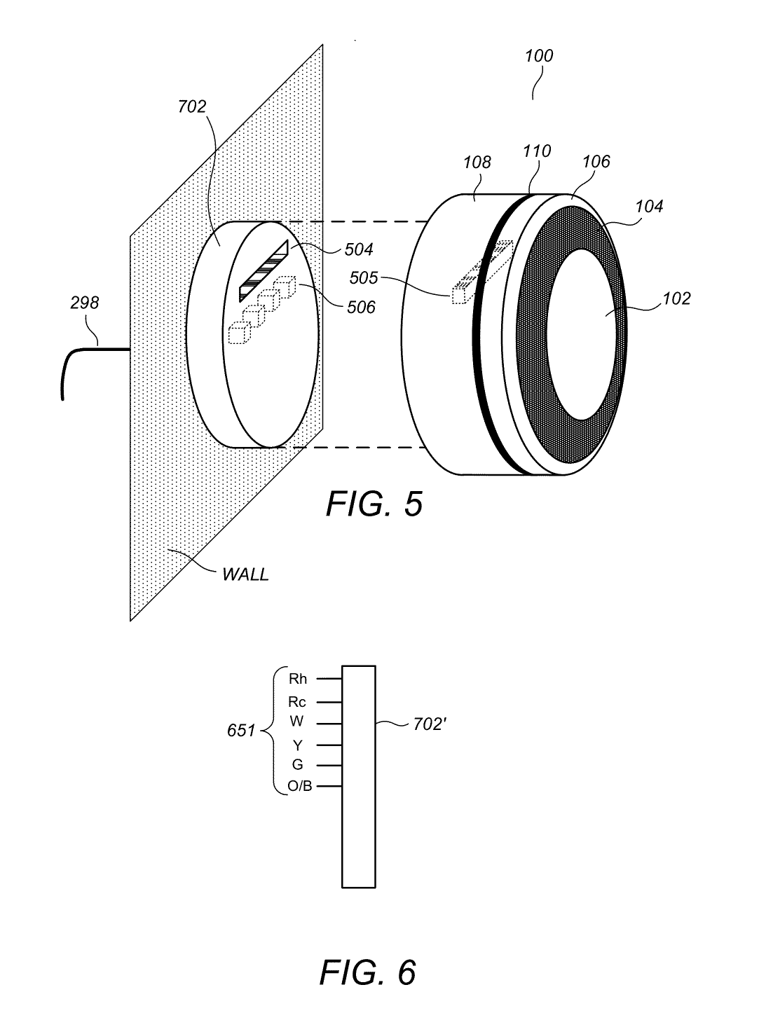

FIG. 5 illustrates an exploded perspective view of the VSCU unit 100 and an HVAC-coupling wall dock 702 according to an embodiment. For first-time customers who are going to be replacing their old thermostat, the VSCU unit 100 is provided in combination with HVAC-coupling wall dock 702. The HVAC-coupling wall dock 702 comprises mechanical hardware for attaching to the wall and electrical terminals for connecting to the HVAC wiring 298 that will be extending out of the wall in a disconnected state when the old thermostat is removed. The HVAC-coupling wall dock 702 is configured with an electrical connector 504 that mates to a counterpart electrical connector 505 in the VSCU 100.

For the initial installation process, the customer (or their handyman, or an HVAC professional, etc.) first installs the HVAC-coupling wall dock 702, including all of the necessary mechanical connections to the wall and HVAC wiring connections to the HVAC wiring 298. Once the HVAC-coupling wall dock 702 is installed, which represents the “hard work” of the installation process, the next task is relatively easy, which is simply to slide the VSCU unit 100 thereover to mate the electrical connectors 504/505. Preferably, the components are configured such that the HVAC-connecting wall dock 702 is entirely hidden underneath and inside the VSCU unit 100, such that only the visually appealing VSCU unit 100 is visible.

For one embodiment, the HVAC-connecting wall dock 702 is a relatively “bare bones” device having the sole essential function of facilitating electrical connectivity between the HVAC wiring 298 and the VSCU unit 100. For another embodiment, the HVAC-coupling wall dock 702 is equipped to perform and/or facilitate, in either a duplicative sense and/or a primary sense without limitation, one or more of the functionalities attributed to the VSCU unit 100 in the instant disclosure, using a set of electrical, mechanical, and/or electromechanical components 706. One particularly useful functionality is for the components 706 to include power-extraction circuitry for judiciously extracting usable power from the HVAC wiring 298, at least one of which will be carrying a 24-volt AC signals in accordance with common HVAC wiring practice. The power-extraction circuitry converts the 24-volt AC signal into DC power (such as at 5 VDC, 3.3 VDC, etc.) that is usable by the processing circuitry and display components of the main unit 701. Another functionality of electromechanical components 706 is that they may serve conventional thermostatic purposes when VSCU unit 100 is not mated to wall dock 702, such as when VSCU needs servicing or replacement. For example electromechanical components 706 may include HEAT-COOL toggle switch, or HEAT-OFF-COOL selection switch, or HEAT-FAN-OFF-COOL switch, and a button to adjust the set point temperature to be displayed on a simple screen (e.g., LCD), where wall dock 702 is also connected to temperature sensors for knowing the ambient temperature. In this configuration, wall dock 702 can function as a conventional thermostat while VSCU 100 is not mated thereto, and when the VSCU 100 is mated to wall dock 702, according to this embodiment, VSCU 100 would over ride the conventional thermostatic functionality of wall dock 702. Further details of this embodiment are provided below. As will be appreciated, wall dock 702 may also house any number of sensors used either by wall dock 702 when operating in the conventional mode, or by VSCU 100 when mounted to wall dock 702.

The division and/or duplication of functionality between the VSCU unit 100 and the HVAC-coupling wall dock 702 can be provided in many different ways without departing from the scope of the present teachings. For another embodiment, the components 706 of the HVAC-coupling wall dock 702 can include one or more sensing devices, such as an acoustic sensor, for complementing the sensors provided on the sensor ring 104 of the VSCU unit 100. For another embodiment, the components 706 can include wireless communication circuitry compatible with one or more wireless communication protocols, such as the Wi-Fi and/or ZigBee protocols. For another embodiment, the components 706 can include external AC or DC power connectors. For another embodiment, the components 706 can include wired data communications jacks, such as an RJ45 Ethernet jack, an RJ11 telephone jack, or a USB connector.

The docking capability of the VSCU unit 100 according to the embodiment of FIG. 4 provides many advantages and opportunities in both a technology sense and a business sense. Because the VSCU unit 100 can be easily removed and replaced by even the most non-technically-savvy customer, many upgrading and upselling opportunities are provided. For example, many different versions of the VSCU unit 100 can be separately sold, the different versions having different colors, styles, themes, and so forth. Upgrading to a new VSCU unit 100 having more advanced capabilities becomes a very easy task, and so the customer will be readily able to take advantage of the newest display technology, sensor technology, more memory, and so forth as the technology improves over time.

Provided in accordance with one or more embodiments related to the docking capability shown in FIG. 5 are further devices and features that advantageously promote expandability of the number of sensing and control nodes that can be provided throughout the home. For one embodiment, a tabletop docking station (not shown) is provided that is capable of docking to a second instance of the VSCU unit 100, which is termed herein an auxiliary VSCU unit (not shown). The tabletop docking station and the auxiliary VSCU unit can be separately purchased by the user, either at the same time they purchase their original VSCU unit 100, or at a later time. The tabletop docking station is similar in functionality to the HVAC-coupling wall dock 702, except that it does not require connection to the HVAC wiring 298 and is conveniently powered by a standard wall outlet or other electrical source separate from the HVAC system wiring. For another embodiment, instead of being identical to the original VSCU unit 100, the auxiliary VSCU unit can be a differently labeled and/or differently abled version thereof.

As used herein, the term “primary VSCU unit” refers to one that is electrically connected to actuate an HVAC system in whole or in part, which would necessarily include the first VSCU unit purchased for any home, while the term “auxiliary VSCU unit” refers to one or more additional VSCU units not electrically connected to actuate an HVAC system in whole or in part. An auxiliary VSCU unit, when docked, will automatically detect the primary VSCU unit and will automatically be detected by the primary VSCU unit, such as by Wi-Fi or ZigBee wireless communication. Although the primary VSCU unit will remain the sole provider of electrical actuation signals to the HVAC system, the two VSCU units will otherwise cooperate in unison for improved control heating and cooling control functionality, such improvement being enabled by virtue of the added multi-sensing functionality provided by the auxiliary VSCU unit, as well as by virtue of the additional processing power provided to accommodate more powerful and precise control algorithms. Because the auxiliary VSCU unit can accept user control inputs just like the primary VSCU unit, user convenience is also enhanced. Thus, for example, where the tabletop docking station and the auxiliary VSCU unit are placed on a nightstand next to the user's bed, the user is not required to get up and walk to the location of the primary VSCU unit if they wish to manipulate the temperature set point, view their energy usage, or otherwise interact with the system.

A variety of different VSCU-compatible docking stations are within the scope of the present teachings. For example, in another embodiment there is provided an auxiliary wall dock (not shown) that allows an auxiliary VSCU unit to be mounted on a wall. The auxiliary wall dock is similar in functionality to the tabletop docking station in that it does not provide HVAC wiring connections, but does serve as a physical mounting point and provides electrical power derived from a standard wall outlet.

For one embodiment, all VSCU units sold by the manufacturer are identical in their core functionality, each being able to serve as either a primary VSCU unit or auxiliary VSCU unit as the case requires, although the different VSCU units may have different colors, ornamental designs, memory capacities, and so forth. For this embodiment, the user is advantageously able, if they desire, to interchange the positions of their VSCU units by simple removal of each one from its existing docking station and placement into a different docking station. Among other advantages, there is an environmentally, technically, and commercially appealing ability for the customer to upgrade to the newest, latest VSCU designs and technologies without the need to throw away the existing VSCU unit. For example, a customer with a single VSCU unit (which is necessarily serving as a primary VSCU unit) may be getting tired of its color or its TFT display, and may be attracted to a newly released VSCU unit with a different color and a sleek new OLED display. For this case, in addition to buying the newly released VSCU, the customer can buy a tabletop docking station to put on their nightstand. The customer can then insert their new VSCU unit into the existing HVAC-coupling wall dock, and then take their old VSCU unit and insert it into the tabletop docking station. Advantageously, in addition to avoiding the wastefulness of discarding the old VSCU unit, there is now a new auxiliary VSCU unit at the bedside that not only provides increased comfort and convenience, but that also promotes increased energy efficiency by virtue of the additional multi-sensor information and processing power provided.

For other embodiments, different VSCU units sold by the manufacturer can have different functionalities in terms of their ability to serve as primary versus auxiliary VSCU units. This may be advantageous from a pricing perspective, since the hardware cost of an auxiliary-only VSCU unit may be substantially less than that of a dual-capability primary/auxiliary VSCU unit. In other embodiments there is provided distinct docking station capability for primary versus auxiliary VSCU units, with primary VSCU units using one kind of docking connection system and auxiliary VSCU units using a different kind of docking connection system. In still other embodiments there is provided the docking station capability of FIG. 5 for primary VSCU units, but no docking station capability for auxiliary VSCU units, wherein auxiliary VSCU units are simply provided in monolithic form as dedicated auxiliary tabletop VSCU units, dedicated auxiliary wall-mounted VSCU units, and so forth. One advantage of providing an auxiliary VSCU unit, such as a tabletop VSCU unit, without a docking functionality would be its simplicity and non-intimidating nature for users, since the user would simply be required to place it on a table (their nightstand, for example) and just plug it in, just as easily as they would a clock radio.

In still other embodiments, all VSCU units are provided as non-docking types, but are interchangeable in their abilities as primary and auxiliary VSCU units. In still other embodiments, all VSCU units are provided as non-docking types and are non-interchangeable in their primary versus auxiliary abilities, that is, there is a first set of VSCU units that can only serve as primary VSCU units and a second set of VSCU units that can only serve as auxiliary VSCU units. For embodiments in which primary VSCU units are provided as non-docking types, their physical architecture may still be separable into two components for the purpose of streamlining the installation process, with one component being similar to the HVAC-coupling wall dock 702 of FIG. 5 and the second component being the main unit as shown in FIG. 5, except that the assembly is not intended for docking-style user separability after installation is complete. For convenience of description hereinbelow and so as not to unnecessarily limit the scope of the present teachings, the classification of one or more described VSCU units as being of (i) a non-docking type versus a docking type, and/or (ii) a primary type versus an auxiliary type, may not be specified, in which case VSCU units of any of these classifications may be used with such embodiments, or in which case such classification will be readily inferable by the skilled artisan from the context of the description.

FIG. 6A illustrates a conceptual diagram of an HVAC-coupling wall dock 702′ with particular reference to a set of input wiring ports 651 thereof, and which represents a first version of the HVAC-coupling wall dock 702 of FIG. 5 that is manufactured and sold in a “simple” or “DIY (do-it-yourself)” product package in conjunction with the VSCU unit 100. The input wiring ports 651 of the HVAC-coupling wall dock 702′ are judiciously limited in number and selection to represent a business and technical compromise between (i) providing enough control signal inputs to meet the needs of a reasonably large number of HVAC systems in a reasonably large number of households, while also (ii) not intimidating or overwhelming the do-it-yourself customer with an overly complex array of connection points. For one embodiment, the judicious selection of input wiring ports 651 consists of the following set: Rh (24 VAC heating call switch power); Rc (24VAC cooling call switch power); W (heating call); Y (cooling call); G (fan); and O/B (heat pump).

The HVAC-coupling wall dock 702′ is configured and designed in conjunction with the VSCU unit 100, including both hardware aspects and programming aspects, to provide a DIY installation process that is simple, non-intimidating, and perhaps even fun for many DIY installers, and that further provides an appreciable degree of foolproofing capability for protecting the HVAC system from damage and for ensuring that the correct signals are going to the correct equipment. HVAC wiring schemes are well understood to the skilled artisan. In addition, detailed description for wiring and installation of the present VSCU's may be found in one or more of the above-referenced incorporated commonly assigned patent applications. For example, but not by way of limiting the present description, advantageous installation functionality of the present VSCU's may include: automated functional testing of the HVAC system by the VSCU unit 100 based on the wiring insertions made by the installer as detected by the small mechanical detection switches at each distinct input port; and automated determination of the homeowner's pre-existing heat pump wiring convention when an insertion onto the O/B (heat pump) input port is mechanically sensed at initial startup. Therefore, for the sake of brevity and clarity further description of HVAC wiring schemes and wiring and installation of VSCU's will not be provided herein

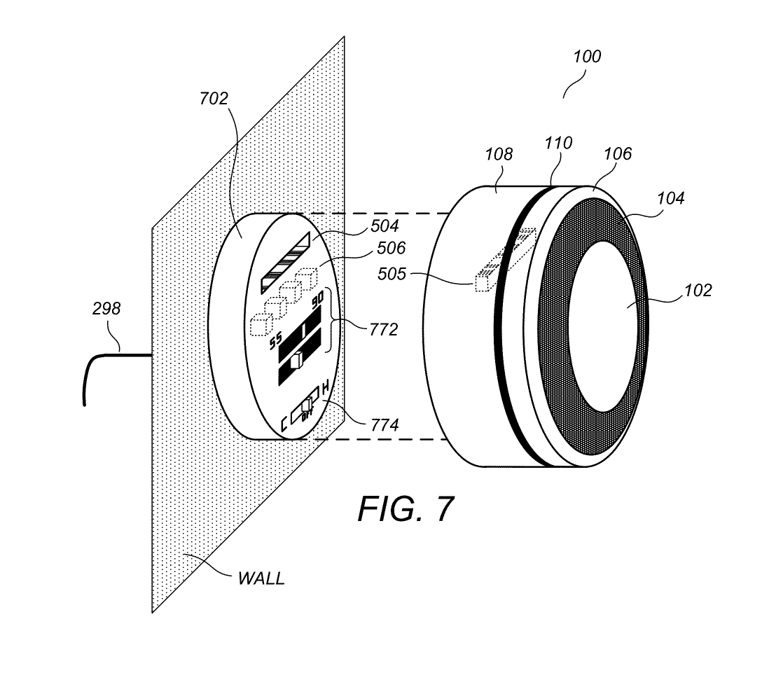

FIG. 7 illustrates an exploded perspective view of the VSCU unit 100 and an HVAC-coupling wall dock 702 according to an embodiment. The HVAC-coupling wall dock 702 is similar to the HVAC-coupling wall dock 702 of FIG. 5, supra, except that it has an additional functionality as a very simple, elemental, standalone thermostat when the VSCU unit 100 is removed, the elemental thermostat including a standard temperature readout/setting dial 772 and a simple COOL-OFF-HEAT switch 774. This can prove useful for a variety of situations, such as if the VSCU 100 needs to be removed for service or repair for an extended period of time over which the occupants would still like to remain reasonably comfortable. For one embodiment, the elemental thermostat components 772 and 774 are entirely mechanical in nature, such that no electrical power is needed to trip the control relays. For other embodiments, simple electronic controls such as electrical up/down buttons and/or an LCD readout are provided. For other embodiments, some subset of the advanced functionalities of the VSCU unit 100 can be provided, such as elemental network access to allow remote control, to provide a sort of “brain stem” functionality while the “brain” (the VSCU unit 100) is temporarily away.

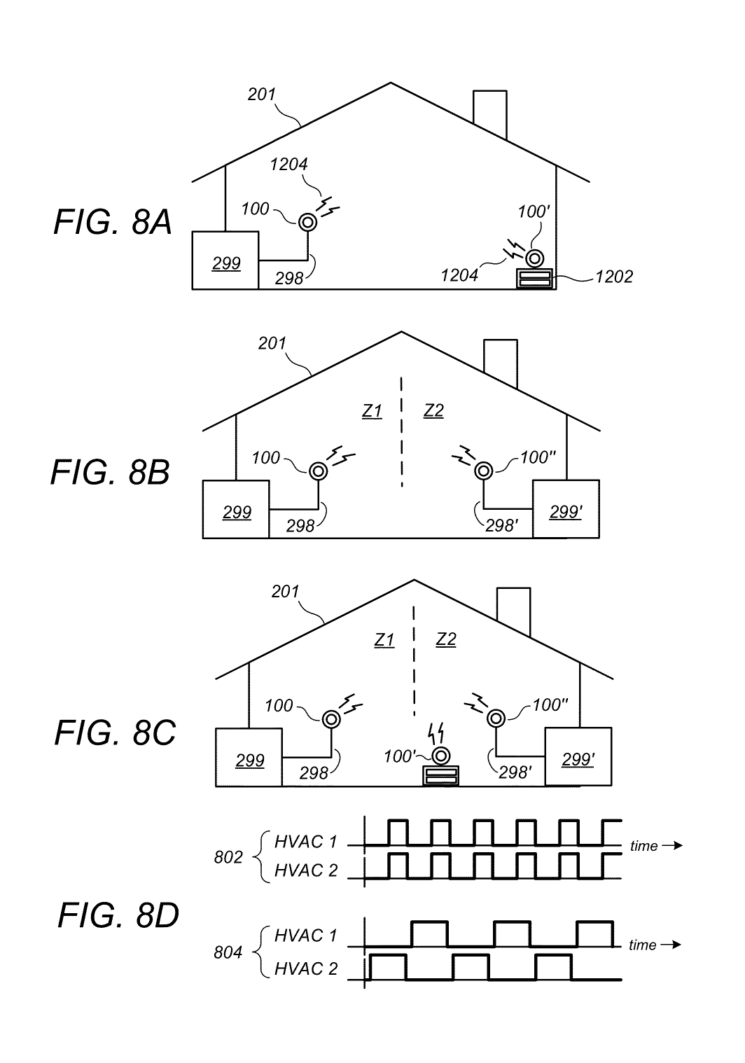

FIGS. 8A-8C illustrate conceptual diagrams representative of advantageous scenarios in which multiple VSCU units are installed in a home 201 (or other space such as retail stores, office buildings, industrial buildings, and more generally any living space or work space having one or more HVAC systems) according to embodiments in which the home (or other space) does not have a wireless data network. For the embodiment of FIG. 8A in which the home 201 has a single HVAC system 298, a primary VSCU unit 100 is installed and connected thereto via the control wires 298, which an auxiliary VSCU unit 100′ is placed, by way of example, on a nightstand 1002. The primary VSCU unit 100 and auxiliary VSCU unit 100′ are each configured to automatically recognize the presence of the other and to communicate with each other using a wireless communication protocol such as Wi-Fi or ZigBee running in an ad hoc mode. As the skilled artisan will appreciate, wireless communication between the VSCU units could also take place over a network as in other embodiments discussed herein.

Many advantageous capabilities are programmed into the VSCU units 100 and 100′ to leverage their communication and multi-sensing capabilities such that they jointly, in a cooperative manner, perform the many VSCU unit functionalities (e.g., “learning” about the home HVAC environment, performing occupancy sensing and prediction, “learning” user comfort preferences, etc.) that do not require Internet access, but can also be used when internet access is available. By way of simple example, in one embodiment the primary VSCU unit 100 receives temperature data from the auxiliary VSCU unit 100′ and computes an average of the two temperatures, controlling the HVAC system 299 such that the average temperature of the home 201 is maintained at the current temperature set point level. Alternatively, VSCU can use a weighted average of the temperature data. Either of the VSCU units may be programmed such that its temperature data has more (or less) weight regarding how to control the HVAC system to achieve a desired set point, which weight could include time of day variables as well. For example, the user may optionally or by default set the weight of the primary VSCU to zero in which case ambient temperature at the auxiliary VSCU would be use solely by the primary VSCU (in this embodiment) to control the HVAC system until the ambient temperature at the auxiliary VSCU reaches the set point. One or more additional auxiliary VSCU units (not shown) may also be positioned at one or more additional locations throughout the home and can become part the ad hoc “home VSCU network.” The scope of the present teachings not being limited to any particular maximum number of auxiliary VSCU units. Among other advantages, adding more auxiliary VSCU units is advantageous in that more accurate occupancy detection is promoted, better determination of spatial temperature gradients and thermal characteristics is facilitated, and additional data processing power is provided.

Preferably, the primary/auxiliary VSCU units 100/100′ are programmed to establish a master/slave relationship, wherein any conflicts in their automated control determinations are resolved in favor of the master VSCU unit, and/or such that any user inputs at the master unit take precedence over any conflicting user inputs made at the slave VSCU unit. Although the primary VSCU unit 100 will likely be the “master” VSCU unit in a beginning or default scenario, the status of any particular VSCU unit as a “master” or “slave” is not dictated solely by its status as a primary or auxiliary VSCU unit. It is also understood that neither thermostat needs to operate as the master the other as the slave, but that they would operate in cooperation with each other. Moreover, the status of any particular VSCU unit as “master” or “slave” is not permanent, but rather is dynamically established to best meet current HVAC control needs as can be best sensed and/or predicted by the VSCU units. For one preferred embodiment, the establishment of “master” versus “slave” status is optimized to best meet the comfort desires of the human occupants as can be best sensed and/or predicted by the VSCU units. By way of example, if each VSCU unit is sensing the presence of multiple occupants in their respective areas, then the primary VSCU unit is established as the master unit and controls the HVAC system 299 such that the average temperature reading of the two VSCU units is maintained at the current set point temperature according to a currently active template schedule (i.e., a schedule of time intervals and set point temperatures for each time interval). However, if no occupants in the home are sensed except for a person in the bedroom (as sensed by the auxiliary VSCU unit 100′ which is positioned on a nightstand in this example, for example by input from the user such as setting of a temperature set point, or turning the power of the unit on (or off to turn control back to the primary unit), or by sensing motion, in cooperation with the primary unit, only in the location of the auxiliary unit), then the auxiliary VSCU unit 100′ becomes the “master” VSCU unit, which commands the “slave” VSCU unit 100 to control the HVAC system 299 such that the temperature in the bedroom, as sensed by the “master” unit, stays at a current set point temperature.

Many other automated master/slave establishment scenarios and control determinations based on human behavioral studies, statistical compilations, and the like are within the scope of the present teachings. In one example, the master-slave determination can be made and/or influenced or supported based on an automated determination of which thermostat is in a better place to more reliably govern the temperature, based on historical and/or testing-observed cycling behavior or other criteria. For example, sensors that are immediately over a heat register will not be reliable and will keep cycling the furnace too often. Nodes that are in bathrooms and in direct sunlight are also less reliable. When there are multiple sensors/nodes, there is an algorithm that determines which one is more reliable, and there is master-slave determination based on those determinations. For some related embodiments, VSCU units automatically determined to be near bathrooms and dishwashers can be assigned custom templates designed to at least partially ameliorate the adverse effects of such placement. As another alternative, the master unit may use an algorithm to establish smartly a set point (other than that set by the user) based on sensed temperature profiles, weather information, sensor location and the like.

The establishment of master-slave status for the primary/auxiliary VSCU units 100/100′ can also be based upon human control inputs. By way of example, if each VSCU unit is sensing the presence of multiple occupants in their respective areas, and then a user manually changes the current set point temperature on one of the two units, that VSCU unit can output the question, “Master Override?” on its circular display monitor 102 (analogous to the query capability shown at FIGS. 5A-5B, supra), along with two answer options “Yes” and “Let VSCU Decide,” with the latter being circled as the default response. On the other hand, if the two VSCUs collectively sense only the presence of that user in the home and no other occupants, then whichever unit was controlled by the user can be established as the master unit, without the need for asking the user for a resolution. By way of further example, the VSCU units 100/100′ can be programmed such that the establishment of master/slave status can be explicitly dictated by the user at system setup time (such as during a setup interview), or at a subsequent configuration time using the menu-driven user interface (see FIG. 5 supra) of one of the two VSCU units. When combined with lockout functionality and/or user-specific identification as described elsewhere in the instant specification, this can be particularly useful where Mom and Dad wish to control the house temperature at night using the VSCU unit in their bedroom, and not for their teenage daughter to control the house temperature at night using the VSCU unit in her bedroom. As an alternative, turning the power of the auxiliary unit on may make this unit the master unit, which would control the HVAC system by virtue of wireless communication (either directly or through a network) with the primary unit connected to the HVAC wiring system and capable of transmitting control signals thereto in accordance to commands received from the auxiliary unit (now the master unit). Conversely, turning the power off to the auxiliary unit, in this example, would turn control back over to the primary unit, making it the master unit. As will be appreciated, any number of inputs can be used to set which unit will act as the master unit.

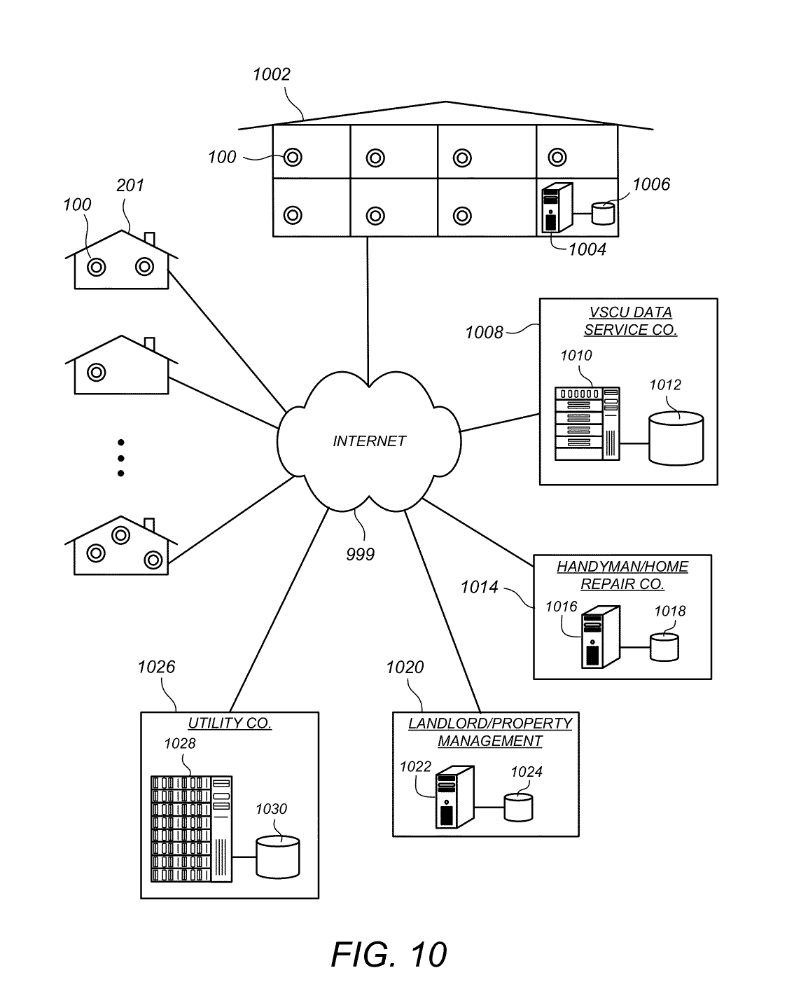

Also provided according to an embodiment is an ability for the multiple VSCU units to judiciously share computing tasks among them in an optimal manner based on power availability and/or circuitry heating criteria. Many of the advanced sensing, prediction, and control algorithms provided with the VSCU unit are relatively complex and computationally intensive, and can result in high power usage and/or device heating if carried out unthrottled. For one embodiment, the intensive computations are automatically distributed such that a majority (or plurality) of them are carried out on a subset of the VSCU units known to have the best power source(s) available at that time, and/or to have known to have the highest amount of stored battery power available. Thus, for example, because it is generally preferable for each primary VSCU unit not to require household AC power for simplicity of installation as well as for equipment safety concerns, the primary VSCU unit 100 of FIG. 10A will often be powered by energy harvesting from one or more of the 24 VAC call relay power signals, and therefore may only have a limited amount of extra power available for carrying out intensive computations. In contrast, a typical auxiliary VSCU unit may be a nightstand unit that can be plugged in as easily as a clock radio. In such cases, much of the computational load can be assigned to the auxiliary VSCU unit so that power is preserved in the primary VSCU unit. In another embodiment, the speed of the intensive data computations carried out by the auxiliary VSCU unit (or, more generally, any VSCU unit to which the heavier computing load is assigned) can be automatically throttled using known techniques to avoid excessive device heating, such that temperature sensing errors in that unit are avoided. In yet another embodiment, the temperature sensing functionality of the VSCU unit(s) to which the heavier computing load is assigned can be temporarily suspended for an interval that includes the duration of the computing time, such that no erroneous control decisions are made if substantial circuitry heating does occur.

Referring now to FIG. 8B, it is often the case that a home or business will have two or more HVAC systems, each of them being responsible for a different zone in the house and being controlled by its own thermostat. Thus, shown in FIG. 8B is a first HVAC system 299 associated with a first zone Z1, and a second HVAC system 299′ associated with a second zone Z2. According to an embodiment, first and second primary VSCU units 100 and 100″ are provided for controlling the respective HVAC units 299 and 299′. The first and second primary VSCU units 100 and 100″ are configured to leverage their communication and multi-sensing capabilities such that they jointly, in a cooperative manner, perform many cooperative communication-based VSCU unit functionalities similar or analogous to those described above with respect to FIG. 8A, and still further cooperative VSCU unit functionalities for multi-zone control as described herein. As illustrated in FIG. 8C, the cooperative functionality of the first and second primary VSCU units 100 and 100″ can be further enhanced by the addition of one or more auxiliary VSCU units 100′ according to further embodiments.

It is to be appreciated that there are other multiple-thermostat scenarios that exist in some homes other than ones for which each thermostat controls a distinct HVAC system, and that multiple VSCU unit installations capable of controlling such systems are within the scope of the present teachings. In some existing home installations there may only be a single furnace or a single air conditioning unit, but the home may still be separated into plural “zones” by virtue of actuated flaps in the ductwork, each “zone” being controlled by its own thermostat. In such settings, two primary VSCU units can be installed and configured to cooperate, optionally in conjunction with one or more auxiliary VSCU units, to provide optimal HVAC system control according to the described embodiments.

FIG. 8D illustrates cycle time plots for two HVAC systems in a two-zone home heating (or cooling) configuration, for purposes of illustrating an advantageous, energy-saving dual-zone control method implemented by dual primary VSCU units such as the VSCU units 100 and 100″ of FIGS. 8B-8C, according to an embodiment. According to an embodiment, the VSCU units 100 and 100″ are configured to mutually cooperate such that their actuation cycle times are staggered with respect to each other to be generally about 180 degrees (π radians) out of phase with each other. Shown in FIG. 8D are two cycle time plots 802 and 1004 that are identical with respect to the total percentage of time (e.g., the total number of minutes in an hour) that the heating (or cooling) units are “ON”. For two adjacent zones such as Z1 and Z2 that are in thermal communication with each other, it has been found that running their heating (or cooling) units without mutually controlled operation can allow the system to stray into a sort of high frequency resonance response (FIG. 8D, plot 802) characterized by rapid temperature fluctuations between the swing points and a relatively high number of cycles per hour, which can reduce energy efficiency due to inertial start-up and shut-down losses. In contrast, when purposely controlled to be mutually out of phase with each other according an embodiment, it has been found that a more stable and lower frequency response behavior occurs (FIG. 8D, plot 1004) characterized by fewer cycles per hour and correspondingly increased energy efficiency.

For one embodiment that is particularly advantageous in the context of non-network-connected VSCU units, the VSCU unit is configured and programmed to use optically sensed information to determine an approximate time of day. For a large majority of installations, regardless of the particular location of installation in the home (the only exceptions being perhaps film photography development labs or other purposely darkened rooms), there will generally be a cyclical 24-hour pattern in terms of the amount of ambient light that is around the VSCU unit. This cyclical 24-hour pattern is automatically sensed, with spurious optical activity such as light fixture actuations being filtered out over many days or weeks if necessary, and optionally using ZIP code information, to establish a rough estimate of the actual time of day. This rough internal clock can be used advantageously for non-network-connected installations to verify and correct a gross clock setting error by the user (such as, but not limited to, reversing AM and PM), or as a basis for asking the user to double-check (using the circular display monitor 102), or to establish a time-of-day clock if the user did not enter a time.

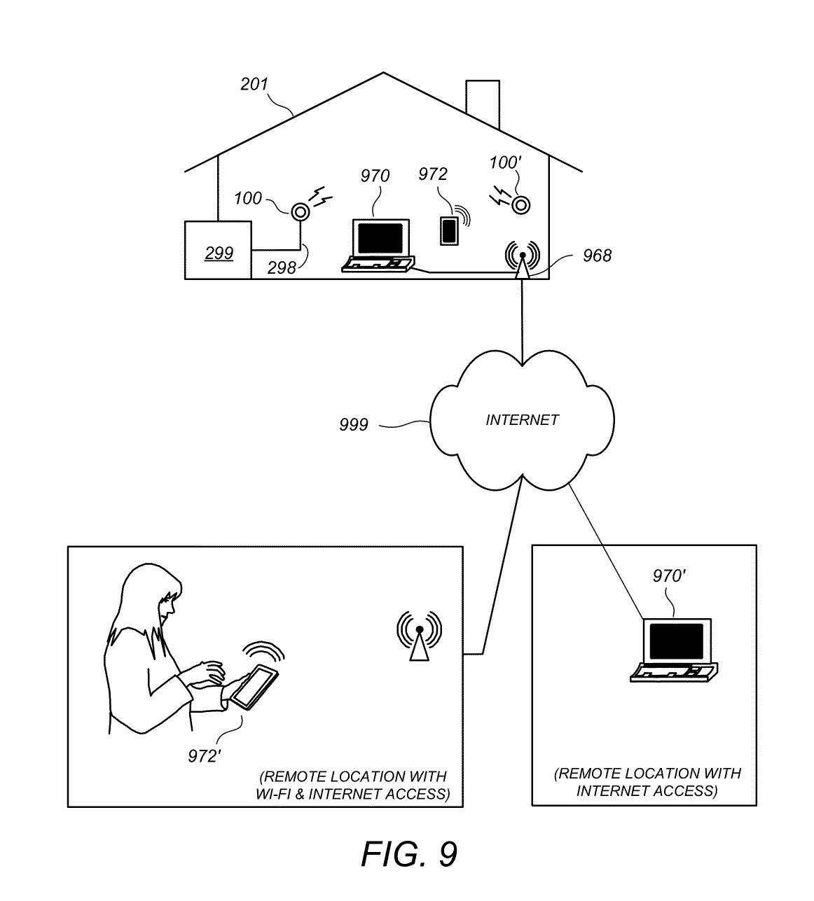

FIG. 9 illustrates a conceptual diagram representative of an advantageous scenario in which one or more VSCU units are installed in a home that is equipped with WiFi wireless connectivity and access to the Internet (or, in more general embodiments, any kind of data connectivity to each VSCU unit and access to a wide area network). Advantageously, in addition to providing the standalone, non-Internet connected functionalities described for FIGS. 8A-8C and elsewhere herein, the connection of one or more VSCU units to the Internet triggers their ability to provide a rich variety of additional capabilities. Shown in FIG. 9 is a primary VSCU unit 100 and auxiliary VSCU unit 100′ having WiFi access to the Internet 999 via a wireless router/Internet gateway 968. Provided according to embodiments is the ability for the user to communicate with the VSCU units 100 and/or 100′ via their home computer 970, their smart phone 972 or other portable data communication appliance 972′, or any other Internet-connected computer 970′.

FIG. 10 illustrates a conceptual diagram of a larger overall energy management network as enabled by the VSCU units and VSCU Efficiency Platform described herein and for which one or more of the systems, methods, computer program products, and related business methods of one or more described embodiments is advantageous applied. The environment of FIG. 10, which could be applicable on any scale (neighborhood, regional, state-wide, country-wide, and even world-wide), includes the following: a plurality of homes 201 each having one or more network-enabled VSCU units 100; an exemplary hotel 1002 (or multi-unit apartment building, etc.) in which each room or unit has a VSCU unit 100, the hotel 1002 further having a computer system 1004 and database 1006 configured for managing the multiple VSCU units and running software programs, or accessing cloud-based services, provisioned and/or supported by the VSCU data service company 1008; a VSCU data service company 1008 having computing equipment 1010 and database equipment 1012 configured for facilitating provisioning and management of VSCU units, VSCU support equipment, and VSCU-related software and subscription services; a handyman or home repair company 1014 having a computer 1016 and database 1018 configured, for example, to remotely monitor and test VSCU operation and automatically trigger dispatch tickets for detected problems, the computer 1016 and database 1018 running software programs or accessing cloud-based services provisioned and/or supported by the VSCU data service company 1008; a landlord or property management company 1020 having a computer 1022 and database 1024 configured, for example, to remotely monitor and/or manage the VSCU operation of their tenants and/or clients, the computer 1022 and database 1024 running software programs, or accessing cloud-based services, provisioned and/or supported by the VSCU data service company 1008; and a utility company 1026 providing HVAC energy to their customers and having computing equipment 1028 and database equipment 1030 for monitoring VSCU unit operation, providing VSCU-usable energy usage data and statistics, and managing and/or controlling VSCU unit set points at peak load times or other times, the computing equipment 1028 and database equipment 1030 running software programs or accessing cloud-based services provisioned and/or supported by the VSCU data service company 1008.

According to one embodiment, each VSCU unit provides external data access at two different functionality levels, one for user-level access with all of the energy gaming and home management functionality described herein, and another for an installer/vendor (“professional”) that lets the professional “check in” on your system, look at all the different remote sensing gauges, and offer to provide and/or automatically provide the user with a service visit.

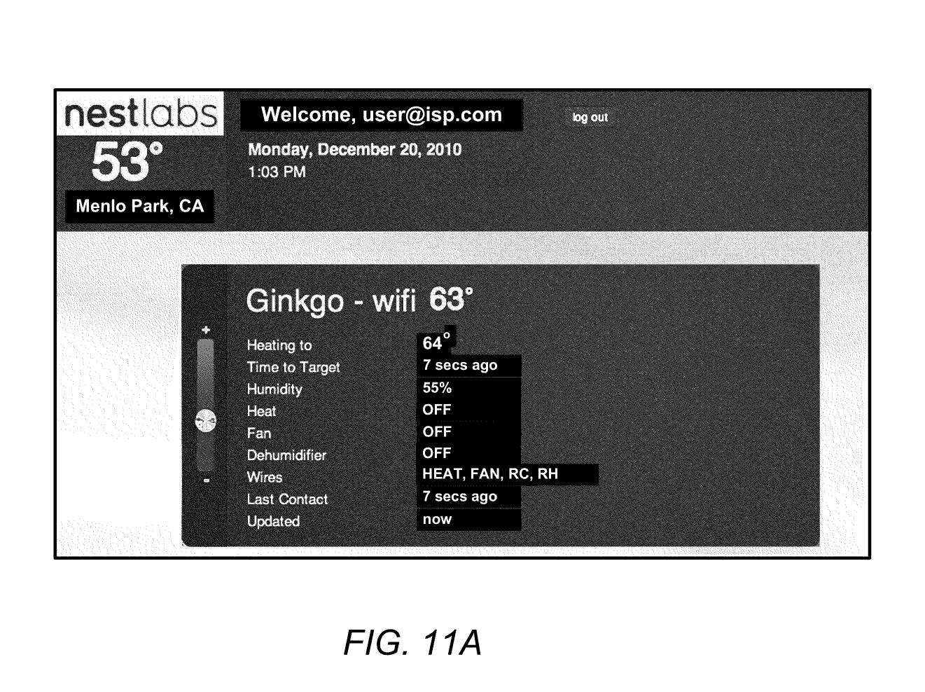

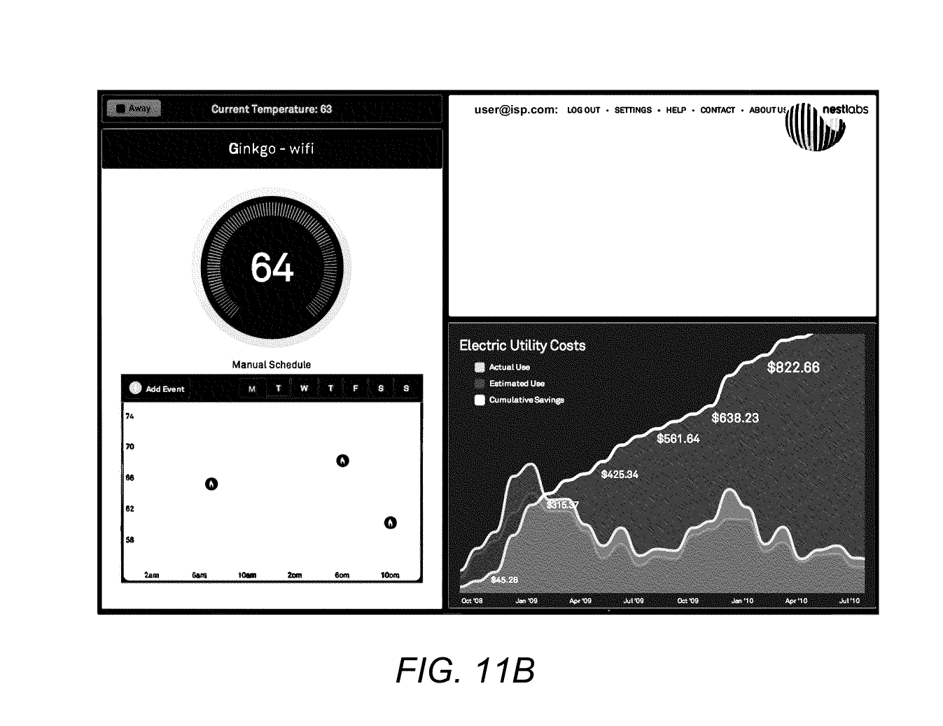

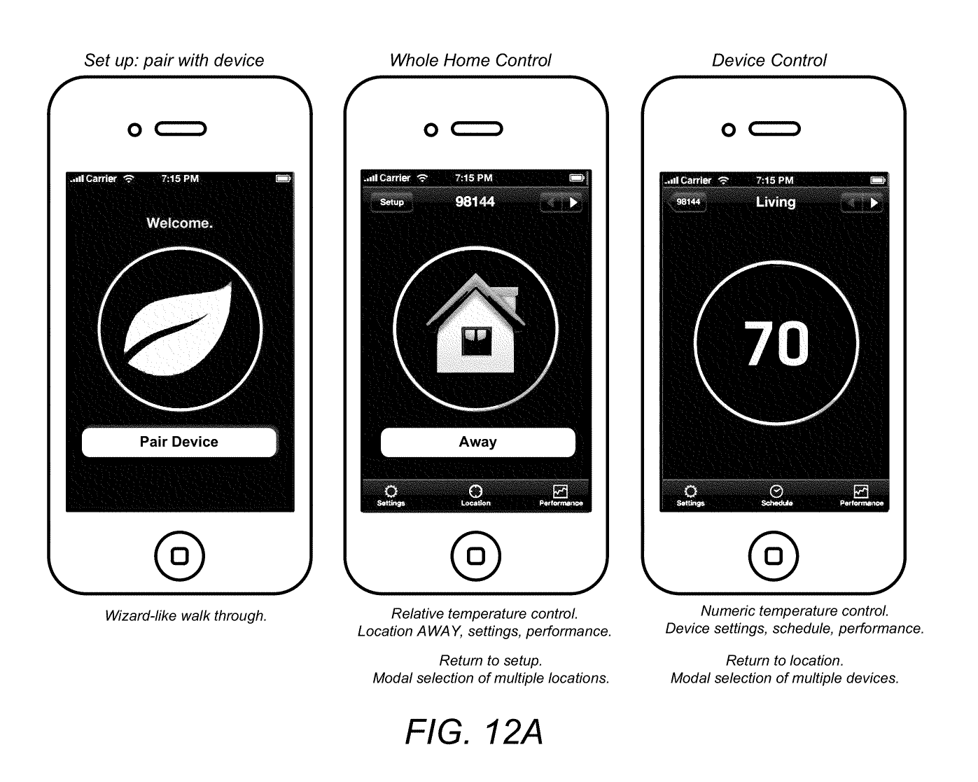

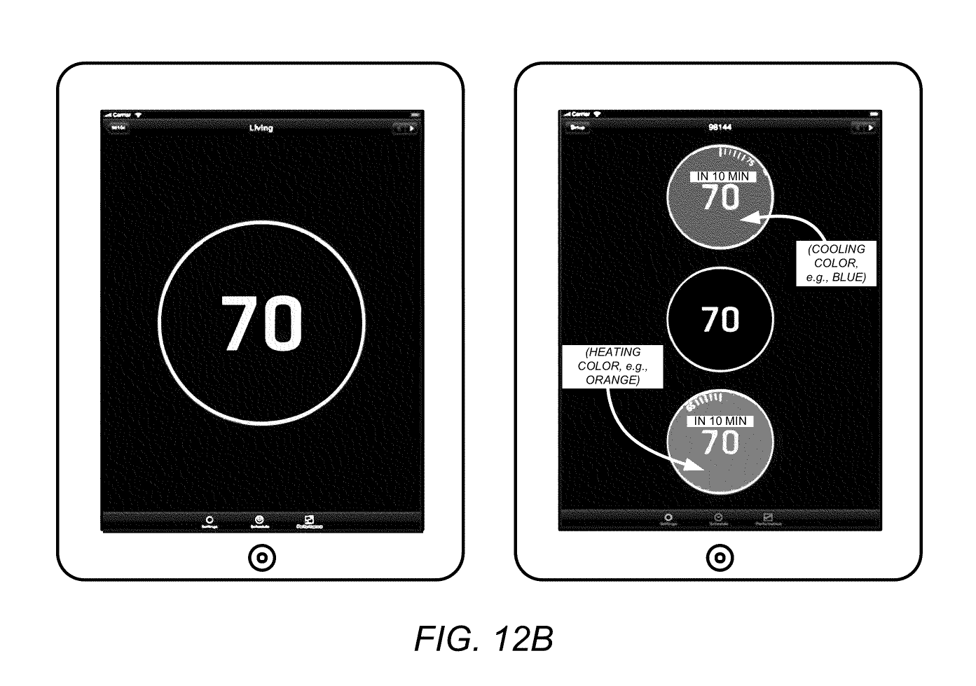

FIGS. 11A-11B and FIGS. 12A-12B illustrate examples of remote graphical user interface displays presented to the user on their data appliance for managing their one or more VSCU units and/or otherwise interacting with their VSCU Efficiency Platform equipment or data according to an embodiment. For one embodiment, one or more of the displays of FIGS. 11A-12B is provided directly by a designated one of the user's own VSCU units, the user logging directly into the device in the same way they can log on to their own home router. For another embodiment, one or more of the displays of FIGS. 11A-12B is displayed when the user logs on to a web site of a central, regional, or local service provider, such as the VSCU data service provider 1008 of FIG. 10, supra, which in turn communicates with the user's VSCU unit(s) over the Internet. Although the scope of the present teachings is not so limited, the examples of FIGS. 11A-11B are particularly suitable for display in a conventional browser window, the example of FIG. 12A is particularly suitable for display on a smaller portable data device such as an iPhone, and the example of FIG. 12B is particularly suitable for display on a larger portable data device such as an iPad. According to one embodiment, the remote user interface includes a relatively large image that is representative of what the user would actually see if they were standing in front of their VSCU unit at that time. Preferably, the user interface allows the user to enter “left ring rotate”, “right ring rotate”, and “inward press” commands thereon just as if they were standing in front of their VSCU unit, such as by suitable swipes, mouse click-and-drags, softbuttons, etc. The remote user interface can also graphically display, and allow the user to graphically manipulate, the set point temperatures and/or time interval limits of their template schedule(s) based on suitable graphs, plots, charts, or other types of data display and manipulation. The remote user interface can also graphically display a variety of other information related to the user's energy usage including, but not limited to, their utility bills and historical energy usage costs and trends, weather information, game-style information showing their performance against other similarly situated households or other suitable populations, and helpful hints, advice, links, and news related to energy conservation.

As will be appreciated by the skilled artisan, the VSCU units and systems incorporating them can utilize any number of sensors or access to other information (weather and the like) to enhance user experience, improve energy conservation, or improve HVAC and general home use improvements. Examples of some sensors include, and not by way of limitation, self-powering and energy-harvesting wireless capable sensors for sensing system anomalies (e.g., maintenance related issues like changing filters, fill levels on outside propane tanks, heating oil tank levels), motion detection (e.g., presence of intruder or user), temperature sensors, pressure sensors, and humidity sensors. Additional embodiments may include the ability for the VSCU units and systems incorporating them to access information on the weather (for example based on ZIP code), and, in combination with information from the user and one or more sensors (remote or built-in), the microprocessors of the VSCU can build a model for the structure to keep it comfortable while conserving energy. Alternatively, this model could be built by a remote computing system and downloaded to the VSCU used to control the HVAC system. Further details and explanations for these sensors, structure modeling and how they may be used may be found in one or more of the above-referenced incorporated commonly assigned patent applications.

In another embodiment the VSCU units are configured and programmed to automatically detect and correct for exposure of one or more VSCU units to direct sunlight or located in a area not providing an accurate representation of house wide ambient temperature (e.g., bathroom, kitchen proximity etc.). Although users are advised, as with any thermostat, to avoid placing the VSCU units in areas of direct sunlight, it has been empirically found that many will place a VSCU unit where it will get direct sunlight for at least part of the day during at least a part of the year. Direct sunlight exposure can substantially confound HVAC system effectiveness because the temperature will be sensed as being incorrectly high, for example, the VSCU unit will measure 80 degrees when it is really only 68 degrees in the room. According to an embodiment, the one or more VSCU units are programmed to detect a direct sunlight exposure situation, such as by temperature tracking over periods of several days to several weeks and then filtering for periodic behaviors characteristic of direct sunlight exposure, and/or filtering for characteristic periodic discrepancies between multiple VSCU units. Correction is then implemented using one more correction methods. Additional examples for where correction methods may be desired include, but not by way of limitation: the user keeps turning up the thermostat above the set points provided in the template schedule, then the VSCU units learn and increase the set points in their template schedule to better match user input; a control algorithm for situations of extended but finite opening of an external door, such as cases in which an occupant is bringing in the Christmas Tree or the groceries; programming the VSCU to learn user occupancy and temperature control patterns; programming and configuration to provide temperature setting governance based on user identity; programming and configuration to automatically switch over from heating to cooling functionality by resolving ambiguity in user intent based on sensed information (part of the elegance of the VSCU unit 100 of FIGS. 1A-1C is the absence of a HEAT-OFF-AC switch); and programming and configuration with a “fingerprinting” functionality to recognize a particular user who is making a current control adjustment at the face of the unit, and then adjusting its response if appropriate for that user. Further details of these above embodiments may be found in one or more of the above-referenced incorporated commonly assigned patent applications.

Numerous specific details are included herein to provide a thorough understanding of the various implementations of the present invention. Those of ordinary skill in the art will realize that these various implementations of the present invention are illustrative only and are not intended to be limiting in any way. Other implementations of the present invention will readily suggest themselves to such skilled persons having the benefit of this disclosure. For example, and not by way of limitation, embodiments of the present invention could be used to economically and judiciously control an irrigation system to conserve water. Sensors for this irrigation system may include soil moisture sensors, sun light sensors, temperature sensors, humidity sensors, barometric pressure sensors and the like, all of which can be used to control irrigation for home or industrial purposes. For some embodiments, one or more of the teachings herein are advantageously applied for an intelligent, network-connected thermostat as described in one or more of the following commonly assigned applications, each of which is incorporated by reference herein: U.S. Ser. No. 13/351,688 filed Jan. 17, 2012; U.S. Ser. No. 13/356,762 filed Jan. 24, 2012; U.S. Ser. No. 13/467,029 filed May 8, 2012; U.S. Ser. No. 13/466,815 filed May 8, 2012; U.S. Ser. No. 13/624,878 filed Sep. 21, 2012; and U.S. Ser. No. 13/624,881 filed Sep. 21, 2012.

In addition, for clarity purposes, not all of the routine features of the implementations described herein are shown or described. One of ordinary skill in the art would readily appreciate that in the development of any such actual implementation, numerous implementation-specific decisions may be required to achieve specific design objectives. These design objectives will vary from one implementation to another and from one developer to another. Moreover, it will be appreciated that such a development effort might be complex and time-consuming but would nevertheless be a routine engineering undertaking for those of ordinary skill in the art having the benefit of this disclosure. Accordingly, the present invention is not limited to the above-described implementations, but instead is defined by the appended claims in light of their full scope of equivalents.

What is claimed is:

1. A temperature control system comprising:
a. one or more temperature sensors for receiving ambient air temperature data;
b. a first docking thermostat comprising
a first housing;
a first user-interface component including a first interactive graphical user interface configured to receive control inputs from a user;
a first microprocessor within said first housing in operative communication with at least a first of said one or more temperature sensors, said first microprocessor in operative communication with said first user-interface component; and
a first electrical connector coupled to said first microprocessor;
c. a second docking thermostat comprising:
a second housing;
a second user-interface component including a second interactive graphical user interface configured to receive control inputs from the user;
a second microprocessor within said second housing in operative communication with at least a second of said one or more temperature sensors, said second microprocessor in operative communication with said second user-interface component;
a second electrical connector coupled to said second microprocessor;
d. a first wireless communication module;
e. a second wireless communication module;
f. a first HVAC docking device configured to mateably and removably receive said first docking thermostat or said second docking thermostat, said first HVAC docking device including a third electrical connector mateable with said first electrical connector associated with said first docking thermostat or with said second electrical connector associated with said second docking thermostat, wherein said first HVAC docking device is coupled to an HVAC system by one or more HVAC wires in wired communication therewith enabling transmission of control signals to said HVAC system and providing a source of AC power to either said first docking thermostat or said second docking thermostat from said one or more HVAC wires;
g. a second docking device configured to mateably and removably receive said second docking thermostat or said first docking thermostat, said second docking device including a fourth electrical connector mateable with said second electrical connector associated with said second docking thermostat or with said first electrical connector associated with said first docking thermostat, wherein said second docking device is not in wired communication with said HVAC system, and wherein said second docking device is configured to couple to a power source other than said one or more HVAC wires leading to said HVAC system;
h. said temperature control system capable of having a first configuration in which said second docking thermostat is mated to said second docking device and said first docking thermostat is mated to said first HVAC docking device, said second docking thermostat can at least partially control said HVAC system by wireless communication with said first docking thermostat, and said first docking thermostat is capable of transmitting control signals to said HVAC system in accordance with instructions communicated from said second docking thermostat; and
i. said temperature control system capable of having a second configuration in which said second docking thermostat is mated to said first HVAC docking device and said first docking thermostat is mated to said second docking device, said first docking thermostat can at least partially control said HVAC system by wireless communication with said second docking thermostat, and said second docking thermostat is capable of transmitting control signals to said HVAC system in accordance with instructions communicated from said first docking thermostat.

2. The temperature control system according to claim 1, wherein said first wireless communication module is located within said first housing and in electrical communication with said first microprocessor, and wherein said second wireless communication module is located within said second housing and in electrical communication with said second microprocessor.

3. The temperature control system according to claim 1, wherein said first wireless communication module is located within said first HVAC docking device and electrically connected to said third electrical connector, and wherein said second wireless communication module is located within said second docking device and electrically connected to said fourth electrical connector.

4. The temperature control system according to claim 1, wherein said second docking thermostat in said first configuration may establish a temperature set point for said temperature control system based on control input from the user to said second docking thermostat, and wherein said first docking thermostat in said second configuration may establish a temperature set point for said temperature control system based on control input from the user to said first docking thermostat.

5. The temperature control system according to claim 4, wherein said second docking thermostat in said first configuration uses ambient temperature data from said at least second of said one or more temperature sensors to control said HVAC system to achieve said set point, and wherein said first docking thermostat in said second configuration uses ambient temperature from said at least first of said one or more temperature sensors to control said HVAC system to achieve said set point.

6. The temperature control system according to claim 4, wherein said second docking thermostat in said first configuration uses an arithmetic average of ambient temperature data from said at least second of said one or more temperature sensors and temperature data from said at least first of said one or more temperature sensors to control said HVAC system to achieve said temperature set point, and wherein said first docking thermostat in said second configuration uses an arithmetic average of ambient temperature data from said at least first of said one or more temperature sensors and ambient temperature data from said at least second of said one or more temperature sensors to control said HVAC system to achieve said temperature set point.

7. The temperature control system according to claim 4, wherein said second docking thermostat in said first configuration uses a weighted average of ambient temperature data from said at least second of said one or more temperature sensors and temperature data from said at least first of said one or more temperature sensors to control said HVAC system to achieve said temperature set point, and wherein said first docking thermostat in said second configuration uses a weighted average of ambient temperature data from said at least first of said one or more temperature sensors and ambient temperature data from said at least second of said one or more temperature sensors to control said HVAC system to achieve said temperature set point.

8. The temperature control system according to claim 4, wherein user control input comprises the user electrically connecting said second docking device to said alternative power source, thereby turning on said second docking device.

9. The temperature control system according to claim 1 further comprising one or more motion sensors, wherein said first docking thermostat and second docking thermostat are configured to use information from said one or more motion sensors to determine which of said first docking thermostat or said second docking thermostat will act as a master and the other as a slave.

10. The temperature control system according to claim 1, wherein said second docking device can be coupled to a power source selected from the group consisting of a non rechargeable battery, a rechargeable battery, direct wired AC source but not from said HVAC system, an AC wall outlet and rechargeable battery, and an AC wall outlet.

11. The temperature control system according to claim 1, wherein at least said first of said one or more first temperature sensors resides remotely from said first docking thermostat, and wherein at least said second of said one or more temperature sensors resides remotely from said second docking thermostat.

12. The temperature control system according to claim 11, wherein at least said first of said one or more first temperature sensors resides in said first HVAC docking device, and wherein at least said second of said one or more temperature sensors resides in said second docking device.

13. The temperature control system according to claim 1, wherein said at least first of said one or more temperature sensors is operatively connected with said first microprocessor via wireless communication, and wherein said at least second of said one or more second temperature sensors is operatively connected to said second microprocessor via wireless communication.

14. The temperature control system according to claim 1, wherein at least said first of one of said one or more temperature sensors is electrically connected with said first microprocessor and resides in said first housing, and wherein at least said second of one of said one or more temperature sensors is electrically connected to said second microprocessor and resides in said second housing.

15. The temperature control system according to claim 1, wherein said first HVAC docking device comprises a simplified nonprogrammable thermostat when not mated with either said first docking thermostat or said second docking thermostat, said simplified nonprogrammable thermostat comprising:
a. an HVAC docking device temperature sensor;
b. a display element for displaying ambient temperature data from said HVAC docking device temperature sensor,
c. a control used to adjust said set point; and
d. physical switches used to switch control of said simplified nonprogrammable thermostat to heat, cool, on or off when said HVAC docking device functions as said nonprogrammable thermostat.

16. The temperature control system according to claim 15, wherein said HVAC docking device temperature sensor is one of said one or more temperature sensors.

17. A temperature control system comprising:
a. one or more temperature sensors for receiving ambient air temperature data;
b. a first docking thermostat comprising
a first housing;
a first user-interface component including a first interactive graphical user interface configured to receive control inputs from a user;
a first microprocessor within said first housing in operative communication with at least a first of said one or more temperature sensors, said first microprocessor in operative communication with said first user-interface component;
a first electrical connector coupled to said first microprocessor;
c. a second docking thermostat interchangeable with said first docking thermostat, said second docking thermostat comprising:
a second housing;
a second user-interface component including a second interactive graphical user interface configured to receive control inputs from the user;
a second microprocessor within said second housing in operative communication with at least a second of said one or more temperature sensors, said second microprocessor in operative communication with said second user-interface component;
a second electrical connector coupled to said second microprocessor;
d. a first wireless communication module;
e. a second wireless communication module;
f. a first HVAC docking device configured to mateably and removably receive said first docking thermostat or said second docking thermostat, said first HVAC docking device including a third electrical connector mateable with said first electrical connector associated with said first docking thermostat or with said second electrical connector associated with said second docking thermostat, wherein said first HVAC docking device is coupled to an HVAC system by one or more HVAC wires in wired communication therewith enabling transmission of control signals to said HVAC system and providing a source of AC power to either said first docking thermostat or said second docking thermostat from said one or more HVAC wires; and
g. a second docking device configured to mateably and removably receive said second docking thermostat or said first docking thermostat, said second docking device including a fourth electrical connector mateable with said second electrical connector associated with said second docking thermostat or with said first electrical connector associated with said first docking thermostat, wherein said second docking device is not in wired communication with said HVAC system, and wherein said second docking device is configured to couple to a power source other than said one or more HVAC wires leading to said HVAC system.

18. The temperature control system according to claim 17, wherein either said first docking thermostat or said second docking thermostat operates as a master based on user input.

19. The temperature control system according to claim 18, where in user input is setting a temperature set point using either said first interactive graphical user interface or said second interactive graphical user interface.

20. The temperature control system according to claim 18, wherein user input is turning the turning power on or off for said first docking thermostat or said second docking thermostat, whichever is mated to said second docking device.

21. The temperature control system according to claim 17, wherein said first docking thermostat is mated with said first HVAC docking device and said second docking thermostat is mated with said second docking device, and wherein said first docking thermostat operates as a master and the second docking thermostat operates as a slave.

22. The temperature control system according to claim 21, wherein said first docking thermostat wirelessly obtains ambient temperature data from at least said second temperature sensor by wireless communication with said second microprocessor.

23. The temperature control system according to claim 22, wherein said first docking thermostat computes a set point based on ambient temperature data from at least said first of said one or more temperature sensors and ambient temperature data from at least said second of said one or more temperature sensors.

24. The temperature control system according to claim 22, wherein said first docking thermostat computes an arithmetic average of ambient temperature data from at least said first of said one or more temperature sensors and ambient temperature data from at least said second of said one or more temperature sensors, and wherein said first docking thermostat controls said HVAC system to have said arithmetic average of ambient temperature data achieve said temperature set point.

25. The temperature control system according to claim 17, wherein said first docking thermostat is mated with said first HVAC docking device and said second docking thermostat is mated with said second docking devices, and wherein said second docking thermostat operates as a master and the first docking thermostat operates as a slave.

26. The temperature control system according to claim 25, wherein said second docking thermostat wirelessly obtains ambient temperature data from at least said first temperature sensor by wireless communication with said first microprocessor.

27. The temperature control system according to claim 26, wherein said second docking thermostat computes a set point based on ambient temperature data from at least said second of said one or more temperature sensors and ambient temperature data from at least said first of said one or more temperature sensors.

28. The temperature control system according to claim 26, wherein said second docking thermostat computes an arithmetic average of ambient temperature data from at least said second of said one or more temperature sensors and ambient temperature data from at least said first of said one or more temperature sensors, and wherein said second docking thermostat controls said HVAC system to have said arithmetic average of ambient temperature data achieve said temperature set point.

29. The temperature control system according to claim 17, wherein said second docking thermostat is mated with said first HVAC docking device and said first docking thermostat is mated with said second docking device, and wherein said second docking thermostat operates as a master and the first docking thermostat operates as a slave.

30. The temperature control system according to claim 29, wherein said second docking thermostat wirelessly obtains ambient temperature data from at least said first temperature sensor by wireless communication with said first microprocessor.

31. The temperature control system according to claim 30, wherein said second docking thermostat computes a set point based on ambient temperature data from at least said second of said one or more temperature sensors and ambient temperature data from at least said first of said one or more temperature sensors.

32. The temperature control system according to claim 30, wherein said second docking thermostat computes an arithmetic average of ambient temperature data from at least said second of said one or more temperature sensors and ambient temperature data from at least said first of said one or more temperature sensors, and wherein said second docking thermostat controls said HVAC system to have said arithmetic average of ambient temperature data achieve said temperature set point.

33. The temperature control system according to claim 17, wherein said second docking thermostat is mated with said first HVAC docking device and said first docking thermostat is mated with said second docking devices, and wherein said first docking thermostat operates as a master and said second docking thermostat operates as a slave.

34. The temperature control system according to claim 33, wherein said first docking thermostat wirelessly obtains ambient temperature data from at least said second temperature sensor by wireless communication with said second microprocessor.

35. The temperature control system according to claim 34, wherein said first docking thermostat computes a set point based on ambient temperature data from at least said first of said one or more temperature sensors and ambient temperature data from at least said second of said one or more temperature sensors.

36. The temperature control system according to claim 34, wherein said first docking thermostat computes an arithmetic average of ambient temperature data from at least said first of said one or more temperature sensors and ambient temperature data from at least said second of said one or more temperature sensors, and wherein said first docking thermostat controls said HVAC system by wireless communication to said second docking thermostat to have said arithmetic average of ambient temperature data to achieve said temperature set point.
